(19) United States
(12) Patent Application Publication
(10) Pub. No.: US 2025/0133439 A1
(43) Pub. Date: Apr. 24, 2025

(54) First Node, Second Node and Third Node, Communications System and Methods Performed, Thereby for Handling Mobility of One or More Ongoing Communication Sessions for a Device

(71) Applicant: Telefonaktiebolaget LM Ericsson (publ), Stockholm (SE)

(72) Inventors: Aleksandra Obeso Duque, Solna (SE); Nanjangud Chandrasekhara Swamy Narendra, Bangalore (IN); Srinivasa Vinay Yadhav, Bangalore (IN)

(21) Appl. No.: 18/683,867

(22) PCT Filed: Aug. 27, 2021
(86) PCT No.: PCT/EP2021/073799

§ 371 Date: Feb. 15, 2024

(51) Int. Cl. H04W 28/02; H04W 28/088; H04W 28/26

(52) U.S. Cl. CPC H04W 28/0268; H04W 28/088; H04W 28/26

(57) ABSTRACT

Method for handling mobility of ongoing communication sessions, from a source (121) to a target domain (122). Each domain comprises at least a first and second communications network (102). Each of the sessions comprises a group of traffic flows having a requirement for a quality of service or experience (QoE). A first node (111) determines (202), for each respective group of flows, in each of the sessions having a similar requirement for QoE: i) a correspondence between a first set of resources belonging to the first communications network (101) and a respective second set of resources belonging to the second communications network (102) required for the shift, and ii) a respective priority in the shift. The second set of resources comprises a respective pair of service meshes. The first node (111) determines (205) a distribution of a time budget for the shift, and provides (206) one or more indications indicating the determined distribution.

### TECHNICAL FIELD

The present disclosure relates generally to a field of handling mobility in a communications network, and more specifically relates to a first node, a second node and a third node and methods performed thereby for handling mobility of one or more ongoing communication sessions for a device, from a source domain to a target domain.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipment's with serving beams.

The standardization organization Third Generation Partnership Project (3GPP) is currently in the process of specifying a New Radio Interface called Next Generation Radio or New Radio (NR) or 5G-UTRA, as well as a Fifth Generation (5G) Packet Core Network, which may be referred to as 5G Core Network, abbreviated as 5G Core (5GC).

In the 5GC, a Session Management Function (SMF) may support different functionalities, e.g., Session Establishment, modify and release, and policy related functionalities such as termination of interfaces towards policy control functions, charging data collection, support of charging interfaces and control and coordination of charging data collection at the User Plane function (UPF). The SMF may receive Policy and Charging Control (PCC) rules from the Policy Control Function (PCF) and may configure the UPF accordingly. The UPF may support handling of user plane (UP) traffic based on the rules received from the SMF, e.g., packet inspection and different enforcement actions such as reporting for charging and Quality of Service (QoS) handling. The PCF may be understood to support a unified policy framework to govern the behavior of the network. The PCF may provide Policy and Charging Control (PCC) rules to the Policy and Charging Enforcement Function (PCEF). The PCF may provide policy rules to a UE through the Access and Mobility Function (AMF). The AMF may manage access of the UE. For example, when the UE may be connected through different access networks, and mobility aspects of the UE. Specifically, the AMF may be used to forward UE rules from the PCF to the UE. An Application Function (AF) may interact with the 3GPP Core Network through a Network Exposure Function (NEF). The AF may allow external parties to use the Exposure Application Program Interfaces (APIs) offered by the network operator. The NEF may support different functionality, e.g., different Exposure APIs.

An end-user consuming an AF via its User Equipment (UE) may have certain Quality of Experience (QoE) requirements. Even when the UE may move across sites, it may require keeping a good QoE with session continuity. Session continuity may typically be achieved with seamless service migration and traffic shifting (TS) approaches between the source and the target domains. A domain may be understood to comprise hardware and software resources supporting a group of applications that may be running on a group of compute machines and interconnected by a group of service meshes comprised in a group of connected networks. A domain may comprise a mobile network (MN), and an edge cloud (EC) network, such as a service mesh-based edge cloud network.

The latest generation of mobile network (5G) may have mobility support based on [1] the following components.

First, an AMF with three different Service and Session Continuity Modes (SSC) providing different levels of disruption during the migration.

Second, efficient Radio Access Network (RAN) handover (HO) based on the concept of Tracking Areas (TAs) lists, in which cells may be grouped into one or more TAs which may be assigned to the UE as a Registration Area (RA). The RA concept may be used as a base for the network to keep track of the UE's location.

Third, support for a Registration Update Procedure upon UE mobility in which the registration type may be set to Mobility Registration Update (MRU). This mechanism may support reselection of a new AMF and transferring of UE-related context.

Fourth, there may be two mechanisms to perform New Generation (NG)-Radio Access Network (RAN) HO. A first mechanism may be Xn-based HO. Xn-based HO may comprise direct handover between NG-RAN nodes via the direct interface, known as Xn interface, including HO preparation and execution stages. At the end of the HO execution, the target NG-RAN node may request the AMF to switch the downlink (DL) data path from the source to the target NG-RAN node. The AMF in turn may request each SMF to switch the data path toward the new NG-RAN node. The SMF may then update the UPF serving the Protocol Data Unit (PDU) session. This Xn-based HO mechanism may only apply for intra-AMF mobility, it cannot be used if there is a need for AMF relocation. A second mechanism may be N2-based HO. N2-based HO may comprise that the NG-RAN node may initiate a handover involving signaling via the 5G Core (5GC) network. It may usually involve AMF relocation. The NG-RAN node may send the signal via the AMF and may include change of AMF and/or SMF/UPF as well. N2-based HO may also involve a preparation and an execution phase. Signaling may always be carried via the core network, but data forwarding may be done either in RAN directly or via a UPF in the core network. This N2-based HO mechanism may be used in case there may be no Xn signaling interface between the source and the target NG-RANs.

Fifth, the latest generation of mobile network (5G) may have mobility support based on the fact that UE-related context data may be transferred across different networks. Sixth, a traffic steering mechanism governed by traffic policies which may be dynamically injected by the SMF and enforced by the UPF. With traffic steering, it may be possible to realize dynamic path selection during service migration, including optimized path selection for session data transfer.

Seventh, selective traffic routing to a Data Network (DN) may facilitate the HO with e.g., an Uplink Classifier (UL-CL) mechanism where the UPF may support diverting traffic to a different (local) PDU Session Anchor (PSA) UPF and merging downlink (DL) traffic towards the UE. This may be achieved based on traffic detection and traffic forwarding rules provided by the SMF to the UPF. As another example, selective traffic routing to a DN may facilitate the HO with an IPv6 Multi-homing mechanism, which may enable a UE to be assigned multiple IPv6 prefixes in a single PDU Session. Each prefix may be served by a separate PSA UPF, and each of them with its own N6 interface to the DN. This UPF may support Branching Point (BP) functionality, which may forward UL traffic toward the different PSA and merge of DL traffic to the UE. A DN may be understood as an IP network external to a mobile network, but which may connect to it.

Eighth, very generic support for AF influence on traffic routing via a control plane (CP) solution. It may allow an AF to provide input to the 5GC for how certain traffic may need to be routed. The AF may send the request either directly to the PCF, or via the NEF, which may in turn send the request to the PCF.

A cloud-based compute environment may support service migration either by e.g., live service migration with a Checkpoint Restore in Userspace (CRIU) tool for migrating containers, or for example, by simple migration by a service replica instantiation in the target domain and replica tear-down in source domain. A cloud-based compute environment may support traffic shifting by e.g., traffic management frameworks such as L4/L7 service mesh, supporting gradual rollout of applications, e.g., blue/green deployments, canary deployments. This may be performed based on mechanisms such as traffic splitting, traffic mirroring, among others, at the level of microservices.

In cloud-native frameworks it is not common to support UE mobility.

Such lack of support for UE mobility in cloud-native frameworks, especially in mobile edge cloud, may result in an interruption of services or significant service quality degradation provided to a UE during mobility, which may thereby negatively affect the performance of the communications network caused by inefficient management of resources, and result in poor user experience.

### SUMMARY

As part of the development of embodiments herein, one or more challenges with the existing technology will first be identified and discussed.

In general, current 3GPP standards [1] for supporting UE mobility mainly cover system and mechanisms in the mobile network, but they do not specify many details regarding the interactions with the AF hosted in the edge cloud (EC). There may be understood to be important details about these cloud-native applications neglected by most 3GPP standards. Cloud-native applications may be generally based on a set of microservices connected as service chains and deployed across distributed data centers (DCs). In the latest mobile network generations, there is a high-level description of how the AF may influence traffic steering in the mobile network but, there are no details of how exactly application interaction may be performed, in particular for efficient UE mobility support.

De-facto standards fostered by the open-source cloud native community are also limited, in the sense that their main focus is on developing cloud-native technologies and frameworks for central, and to some extent, for distributed cloud. However, it seems to be out of their scope up to a great extent how these technologies may need to be adapted for deep EC, which may require very close awareness and interaction with the mobile network to ensure performance guarantees, and not just best-effort performance. In particular, there are no well-known practices on how to design an EC native application which may consider mobility support or how a mobile EC platform may provide complexity abstraction regarding mobility support towards the application.

In the cloud native community, there is a rather new and popular practice or framework for unified traffic management based on the so-called service mesh. L4/L7 service mesh may be understood to support very fine-grain levels of control over the traffic based on strategies such as traffic splitting, traffic mirroring, among others. This traffic management mechanisms may give limited support at the microservice level with a one-hop-oriented approach, e.g., focus on handling communication between a pair of microservices. There may be understood to be a need for having service chain-oriented mechanisms of traffic management, considering not only the performance between each pair of microservices but the influence of the whole service chain.

Currently, L4/L7 service meshes seem inefficient and inadequate for their applicability to mobile EC/telco cloud, in the sense that they do not provide performance guarantees and, on the contrary, may create data path overheads, that is, extra-delays. Furthermore, this framework does not provide special support for requirements of applications hosted in mobile EC, e.g., UE mobility support and differentiated traffic handling.

In short, the procedures for mobility support in the mobile network do not interact or consider information regarding the service migration and traffic shifting in the EC, nor the EC technologies consider information regarding the handover procedure in the mobile network.

Embodiments herein address the unawareness, misalignment and un-coordination between the mobile network and the EC when performing service migration and traffic shifting upon UE mobility events. These problems may be caused by the fragmentation of the different technology domains, e.g., mobile network, cloud and application, due to the separation of concerns involved in the mobile EC ecosystem. It may be understood to be important to address this technology limitations in order to provide performance guarantees required by the more stringent requirements of next-generation applications.

Therefore, it is an object of embodiments herein to improve the handling of mobility in a communications network. Particularly, it is an object of embodiments herein to improve the handling mobility of one or more ongoing communication sessions for a device, from a source domain to a target domain.

According to a first aspect of embodiments herein, the object is achieved by a computer-implemented method, performed by a first node. The method is for handling mobility of one or more ongoing communication sessions for a device, from a source domain to a target domain. Each of the source domain and the target domain comprises at least a first communications network and a second communications network. Each of the one or more ongoing communication sessions comprises a respective group of traffic flows having a respective requirement for a quality of service or experience. The first node operates in at least one of the first communications network, the second communications network, and another communications network. The first node determines, for each respective group of traffic flows, in each of the one or more ongoing communication sessions having a similar requirement for quality of service or experience, a respective correspondence between a respective first set of resources belonging to the first communications network and a respective second set of resources belonging to the second communications network estimated to be required for the shift. The first set of resources comprises a respective pair of core mobile networks, comprising one or more source mobile networks and one or more target mobile networks. The second set of resources comprises a respective pair of service meshes, comprising a source service mesh and a target service mesh. The first node also determines, for each respective group of traffic flows, in each of the one or more ongoing communication sessions having a similar requirement for quality of service or experience a respective priority in the shift for each respective pair of resources. The first node then determines a distribution of a time budget for the shift, between the first communications network and the second communications network. This is performed by exchanging communications with each of the first communications network and the second communications network. The determining of the distribution of the time budget is based on the respective pair of core mobile networks, the respective pair of service meshes and the respective priority, according to a respective end to end performance requirement for the shift. The first node then provides one or more indications to at least one of: a second node operating in the first communications network and a third node operating in the second communications network. The one or more indications indicate the determined distribution.

According to a second aspect of embodiments herein, the object is achieved by a computer-implemented method, performed by the second node. The method is for handling the mobility of the one or more ongoing communication sessions for the device, from the source domain to the target domain. Each of the source domain and the target domain comprises at least the first communications network and the second communications network. Each of the one or more ongoing communication sessions comprises the respective group of traffic flows having the respective requirement for the quality of service or experience. The second node operates in the first communications network. The second node provides, to the first node operating in at least one of the first communications network, the second communications network, and the another communications network, for each respective group of traffic flows in each of the one or more ongoing communication sessions having a similar requirement for quality of service or experience, a first feasible migration budget feasible to the first communications network. The second node then obtains, from the first node, the one or more indications indicating, for each respective group of traffic flows in each of the one or more ongoing communication sessions that are to be shifted from the source domain to the target domain, each of the respective group of traffic flows having the similar requirement for quality of service or experience, the distribution of the time budget for the shift between the source domain and the target domain. The obtained distribution of the time budget is based on the provided first feasible migration budget feasible to the first communications network, and the respective end to end performance requirement for the shift.

According to a third aspect of embodiments herein, the object is achieved by a computer-implemented method, performed by the third node. The method is for handling the mobility of the one or more ongoing communication sessions for the device, from the source domain to the target domain. Each of the source domain and the target domain comprises at least the first communications network and the second communications network. Each of the one or more ongoing communication sessions comprises the respective group of traffic flows having the respective requirement for the quality of service or experience. The third node operates in the second communications network. The third node provides, to the first node operating in at least one of the first communications network, the second communications network, and the another communications network, for each respective group of traffic flows in each of the one or more ongoing communication sessions having a similar requirement for quality of service or experience, a second migration budget feasible to the second communications network. The third node also obtains, from the first node, the one or more third indications indicating, for each respective group of traffic flows in each of the one or more ongoing communication sessions that are to be shifted from the source domain to the target domain, each of the respective group of traffic flows having the similar requirement for quality of service or experience, the distribution of the time budget for the shift between the first communications network and the second communications network. The obtained distribution of the time budget is based on the provided second migration budget feasible to the second communications network.

According to a fourth aspect of embodiments herein, the object is achieved by the first node, for handling the mobility of the one or more ongoing communication sessions for the device, from the source domain to the target domain. Each of the source domain and the target domain is configured to comprise at least the first communications network and the second communications network. Each of the one or more ongoing communication sessions are configured to comprise the respective group of traffic flows having the respective requirement for the quality of service or experience. The first node is configured to operate in at least one of the first communications network, the second communications network, and another communications network. The first node is further configured to determine, for each respective group of traffic flows, in each of the one or more ongoing communication sessions having a similar requirement for quality of service or experience: i) the respective correspondence between the respective first set of resources configured to belong to the first communications network and the respective second set of resources configured to belong to the second communications network configured to be estimated to be required for the shift. The first set of resources is configured to comprise the respective pair of core mobile networks, configured to comprise the one or more source mobile networks and the one or more target mobile networks. The second set of resources are configured to comprise the respective pair of service meshes, configured to comprise the source service mesh and the target service mesh. The first node is also configured to determine, for each respective group of traffic flows, in each of the one or more ongoing communication sessions having a similar requirement for quality of service or experience: ii) the respective priority in the shift for each respective pair of resources. The first node is also configured to determine the distribution of the time budget for the shift, between the first communications network and the second communications network, by exchanging communications with each of the first communications network and the second communications network. The determining of the distribution of the time budget is configured to be based on the respective pair of core mobile networks, the respective pair of service meshes and the respective priority, according to the respective end to end performance requirement for the shift. The first node is further configured to provide the one or more indications to at least one of: the second node configured to operate in the first communications network and the third node configured to operate in the second communications network. The one or more indications are configured to indicate the distribution configured to be determined.

According to a fifth aspect of embodiments herein, the object is achieved by the second node, for handling the mobility of the one or more ongoing communication sessions for the device, from the source domain to the target domain. Each of the source domain and the target domain is configured to comprise at least the first communications network and the second communications network. Each of the one or more ongoing communication sessions are configured to comprise the respective group of traffic flows having the respective requirement for the quality of service or experience. The second node is configured to operate in the first communications network. The second node is further configured to provide, to the first node configured to operate in at least one of the first communications network, the second communications network, and the another communications network, for each respective group of traffic flows in each of the one or more ongoing communication sessions having a similar requirement for quality of service or experience, the first feasible migration budget feasible to the first communications network. The second node is also configured to obtain, from the first node, the one or more third indications configured to indicate, for each respective group of traffic flows in each of the one or more ongoing communication sessions that are to be shifted from the source domain to the target domain, each of the respective group of traffic flows having the similar requirement for quality of service or experience, the distribution of the time budget for the shift between the source domain and the target domain. The distribution of the time budget configured to be obtained is configured to be based on the first feasible migration budget feasible to the first communications network configured to be provided, and the respective end to end performance requirement for the shift.

According to a sixth aspect of embodiments herein, the object is achieved by the third node, for handling the mobility of the one or more ongoing communication sessions for the device, from the source domain to the target domain. Each of the source domain and the target domain is configured to comprise at least the first communications network and the second communications network. Each of the one or more ongoing communication sessions are configured to comprise the respective group of traffic flows having the respective requirement for the quality of service or experience. The third node is configured to operate in the second communications network. The third node is further configured to provide, to the first node configured to operate in at least one of the first communications network, the second communications network, and the another communications network, for each respective group of traffic flows in each of the one or more ongoing communication sessions having a similar requirement for quality of service or experience, the second migration budget feasible to the second communications network. The third node is also configured to obtain, from the first node, the one or more third indications configured to indicate, for each respective group of traffic flows in each of the one or more ongoing communication sessions that are to be shifted from the source domain to the target domain, each of the respective group of traffic flows having the similar requirement for quality of service or experience, the distribution of the time budget for the shift between the first communications network and the second communications network. The distribution of the time budget configured to be obtained is configured to be based on the second migration budget feasible to the second communications network configured to be provided.

As a first advantage, embodiments herein may be understood to be built on top of a novel and converged or aligned traffic differentiation system in the second communications network, e.g., a service mesh-based edge cloud according, to the QoS assurance and UE-session information of the first communications network, e.g., a mobile network.

As another advantage, embodiments herein may be understood to reduce cross-domain signaling, between the first communications network, e.g., a mobile network, and the second communications network, e.g., an edge cloud, based on the concept of groups of traffic flows or traffic aggregates, thus reducing congested inter-domain control planes. This may result into reduction of communication costs and energy savings.

As another advantage, embodiments herein may be understood to enable that signaling forwarding between the first communications network, e.g., mobile network, and the data networks and the data network and the service meshes may be both performed considering the priority associated to the traffic aggregates based on their associated migration budget.

As a further advantage, embodiments herein may be understood to perform dynamic distribution of the available migration budget, e.g., e2e service downtime, between the first communications network, e.g., mobile network and the second communications network, e.g., edge cloud, with optimized selection of traffic shifting strategy and optimized traffic shifting scheduling.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications system, according to embodiments herein.

FIG. 2 is a flowchart depicting embodiments of a method in a first node, according to embodiments herein.

FIG. 3 is a flowchart depicting embodiments of a method in a second node, according to embodiments herein.

FIG. 4 is a flowchart depicting embodiments of a method in a third node, according to embodiments herein.

FIG. 5 is a schematic diagram depicting a non-limiting example of aspects of the methods performed by the first node, the second node and the third node, according to embodiments herein.

FIG. 6 is a schematic diagram depicting a non-limiting example of aspects of the methods performed by the first node, the second node and the third node, according to embodiments herein.

FIG. 7 is a schematic diagram depicting a non-limiting example of aspects of the methods performed by the first node, the second node and the third node, according to embodiments herein.

FIG. 8 is a schematic diagram depicting a non-limiting example of aspects of the methods performed by the first node, the second node and the third node, according to embodiments herein.

FIG. 9 is a schematic diagram depicting a non-limiting example of aspects of the methods performed by the first node, the second node and the third node, according to embodiments herein.

FIG. 10 is a schematic diagram depicting a non-limiting example of aspects of the methods performed by the first node, the second node and the third node, according to embodiments herein.

FIG. 11 is a schematic block diagram illustrating two non-limiting examples, a) and b), of a first node, according to embodiments herein.

FIG. 12 is a schematic block diagram illustrating two non-limiting examples, a) and b), of a second node, according to embodiments herein.

FIG. 13 is a schematic block diagram illustrating two non-limiting examples, a) and b), of a third node, according to embodiments herein.

### DETAILED DESCRIPTION

Certain aspects of the present disclosure and their embodiments may provide solutions to the challenges described in the Summary section or other challenges. There are, proposed herein, various embodiments which address one or more of the issues disclosed herein.

In general terms, embodiments herein may be understood to relate to converged traffic shifting for service mesh-based Mobile EC.

The overarching goal of embodiments herein may be understood to be to provide a converged mechanism for optimized traffic shifting in alignment with the mobile network for mobile edge cloud, upon UE mobility events. Then, the overarching technical effect may be understood to be to provide an efficient traffic steering mechanism that may provide performance guarantees, even upon UE mobility events, by providing seamless, integrated and cloud-native traffic shifting.

Embodiments herein may be based on a new cloud-native approach for traffic management known as L4/L7 service mesh. Furthermore, embodiments herein may enable enhanced traffic shifting in alignment with information and signaling from the mobile network.

Embodiments herein may further aim at enabling a reduction of cross-domain signaling, e.g., mobile network—EC, upon UE mobility by at least one of the following options. As an aspect, embodiments herein provide a mapping between the different levels of traffic aggregation and session management supported by the user plane of the mobile network towards the service mesh-based EC, based on elements composing the mobile network's user-plane, such as PDU sessions, Quality of Service (QoS) flows and Service Data Flows (SDF). As a second aspect, embodiments herein provide a service mesh-based traffic shifting strategy based on aligned traffic flow groups, which may be referred to herein as “Traffic Aggregates”, instead of per microservice pairs, which may be understood to be the generic approach in today's service mesh. As a third aspect, embodiments herein provide an efficient way to propagate mobility event notifications per Traffic Aggregate between the mobile network towards the associated data networks, and from the data network towards the associated service meshes, based on priority information deduced from the associated migration budget.

Embodiments herein may further aim at enabling a dynamically aligned distribution of the available migration budget between the mobile network and the cloud in an optimized way by, as a first option, providing an inter-domain awareness of the status regarding traffic exchange for selecting the most appropriate strategy for efficient traffic shifting in the service mesh, e.g., traffic mirroring, traffic splitting, etc. As a second option, embodiments herein may aim at enabling a dynamically aligned distribution of the available migration budget between the mobile network and the cloud in an optimized way by providing a way to prioritize or organize what traffic aggregates may need to be shifted first in order to meet the migration budget.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

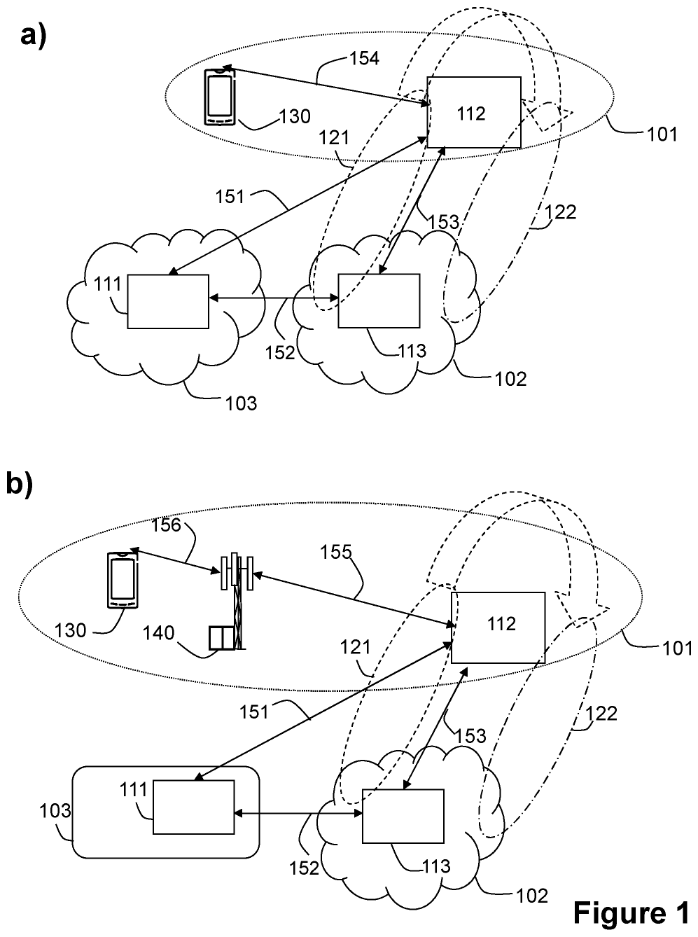

FIG. 1 depicts two non-limiting examples, in panels “a” and “b”, respectively, of a communications system, in which embodiments herein may be implemented. The communications system comprises a first communications network 101 and a second communications network 102. The communications system may, in some embodiments, comprise another communications network 103.

Any of the first communications network 101, and in some examples, the another communications network 103, may be understood to be a mobile network. A mobile network may be understood to refer to a mobile core network which and a network providing, or facilitating, access to the mobile core network via radio, e.g., a RAN or Wi-Fi. The mobile core network mode may be understood to be a central part of the overall mobile network. The mobile network may be understood, for example, to allow mobile subscribers to get access to the services that they may be entitled to use. The mobile core network may be understood to be responsible for functions, such as subscriber profile information, subscriber location, authentication of services and any necessary switching functions for voice and data sessions. Implementation examples may be, e.g., 5G Core (5GC) or Evolved Packet Core (EPC).

Any of the first communications network 101 and the another communications network 103 may be, in some example implementations, such as that depicted in the non-limiting example of FIG. 1a, a computer network. In other example implementations, such as that depicted in the non-limiting example of FIG. 1b, the communications system may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams. In some examples, the telecommunications system may for example be a network such as 5G system, or a newer system supporting similar functionality. In some examples, the telecommunications system may for example be a 4G system, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, etc. The telecommunications system may further support other technologies, such as Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN), Ultra-Mobile Broadband (UMB), EDGE, a network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The second communications network 102, and in some examples, the another communications network 103, may be understood as a network of computers, e.g., servers, in the cloud. Particularly, in some embodiments, any of the first communications network 101, and in some examples, the another communications network 103, may be understood to be an edge cloud network, e.g., a service mesh—based edge cloud. An edge cloud network may be understood to refer to a set of data networks providing connectivity to a cloud ecosystem encompassing storage and compute assets hosting a set of distributed applications or workloads. The edge cloud network may be geographically close to the mobile network points of presence, thus close to the end users it may provide services to.

The another communications network 103 may be understood to be a different network than any of the first communications network 101 and the second communications network 102.

The communications system may comprise a plurality of nodes comprising a first node 111, a second node 112, and a third node 113. Any of the first node 111, the second node 112 and the third node 113 may be understood, respectively, as a first computer system, a second computer system and a third computer system. In some examples, any of the first node 111, the second node 112 and the third node 113 may be implemented as a standalone server in e.g., a host computer in the cloud. Any of the first node 111, the second node 112 and the third node 113 may in some examples be a distributed node or distributed server, with some of their respective functions being implemented locally, e.g., by a client manager, and some of its functions implemented in the cloud, by e.g., a server manager. Yet in other examples, any of the first node 111, the second node 112 and the third node 113 may also be implemented as processing resources in a server farm.

In some embodiments, any of the first node 111, the second node 112 and the third node 113 may be independent and separated nodes. In other embodiments, any of the first node 111 and the third node 113 may be co-located or be the same node. All the possible combinations are not depicted in FIG. 1 to simplify the Figure.

It may be understood that the communications system may comprise more nodes than those represented FIG. 1.

Any of the first node 111, the second node 112, and the third node 113 may be understood as a node having a capability to handle mobility functions. That is, any of the first node 111, the second node 112, and the third node 113 may be understood as a node having a capability to handle mobility of one or more ongoing communication sessions for a device, such as the device 130 described below, from a source domain 121 to a target domain 122. As stated earlier, a domain may be understood to comprise hardware and software resources supporting a group of applications that may be running on a group of compute machines and interconnected by a group of service meshes comprised in a group of connected networks. A domain may comprise a mobile network (MN), and an edge cloud (EC) network, such as a service mesh-based edge cloud network.

The first node 111 operates in at least one of the first communications network 101, the second communications network 102, and the another communications network 103. The first node 111 may be understood as a node handling the interactions between the first communications network 101, e.g., mobile network, and the second communications network 102, e.g., edge cloud, domains. The first node 111 may exchange communications between the first communications network 101 and the second communications network 102. The first node 111 may keep a mapping representation between the topology of the first communications network 101 and the second communications network 102. The first node 111 may be referred to herein as an inter-domain stratum node. In some particular examples, the first node 111 may be implemented as part of a UPF, e.g., in a 5GC network, or as part of an edge cloud management node, e.g., in a service mesh-based edge cloud.

The second node 112 operates in the first communications network 101. The second node 112 may be referred to herein as a mobile network node. In some particular examples, the second node 112 may be a UPF, e.g., in a 5GC network.

The third node 113 operates in the second communications network 102. The third node 113 may be referred to herein as an EC node, e.g., a Service Mesh (SM)-based EC node. In some particular examples, the third node 113 may be an edge cloud management node.

The communications system may comprise a plurality of devices whereof a device 130 is depicted in FIG. 1. The device 130 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles or any other radio network unit capable of communicating over a radio link in the communications system. The device 130 may be wireless, i.e., it may be enabled to communicate wirelessly in the communications system and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system.

The communications system may comprise one or more radio network nodes, whereof a radio network node 140 is depicted in FIG. 1b. The radio network node 140 may typically be a base station or Transmission Point (TP), or any other network unit capable to serve a wireless device or a machine type node in the communications system. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The first node 111 may communicate with the third node 113 over a second link 152, e.g., a radio link or a wired link. The third node 113 may communicate, directly or indirectly, with the second node 112 over a third link 153, e.g., a radio link or a wired link. The second node 112 may communicate, directly or indirectly with the device 130 over a fourth link 154, e.g., a radio link or a wired link. The second node 112 may communicate, directly or indirectly with the radio network node 140 over a fifth link 155, e.g., a radio link or a wired link. The radio network node 140 may communicate with the device 130 over a sixth link 156, e.g., a radio link. Any of the first link 151, the second link 152, the third link 153, the fourth link 154, the fifth link 155, and/or the sixth link 156, may be a direct link or it may go via one or more computer systems or one or more core networks in the communications system, or it may go via an optional intermediate network. The intermediate network may be one of, or a combination of more than one of, a public, private or hosted network; the intermediate network, if any, may be a backbone network or the Internet, which is not shown in FIG. 1.

In general, the usage of “first”, “second”, “third”, “fourth”, “fifth”, and/or “sixth” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

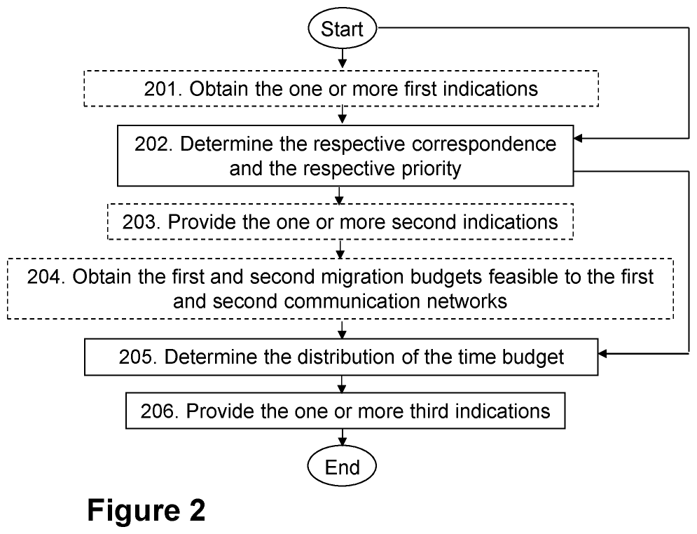

Embodiments of a computer-implemented method, performed by the first node 111, will now be described with reference to the flowchart depicted in FIG. 2. The method may be understood to be for handling mobility of one or more ongoing communication sessions for the device 130, from the source domain 121 to the target domain 122. Each of the source domain 121 and the target domain 122 comprises at least the first communications network 101 and the second communications network 102. Each of the one or more ongoing communication sessions comprises a respective group of traffic flows having a respective requirement for a quality of service or experience. The first node 111 operates in at least one of the first communications network 101, the second communications network 102, and another communications network 103.

As stated earlier, the first communications network 101 may be a mobile network and the second communications network 102 may be an edge cloud network.

The method may comprise the actions described below. In some embodiments all the actions may be performed. In some embodiments some of the actions may be performed. In FIG. 2, optional actions are indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

In FIG. 2, optional actions are represented with dashed boxes.

### Action 201

During the course of communications in the communications system.

In this Action 201, the first node 111 may obtain one or more first indications from the second node 112. The one or more first indications may indicate a respective group of traffic flows in each of one or more ongoing communication sessions, that is ongoing communications sessions for the device 130, that are to be shifted from the source domain 121 to the target domain 122. A group of traffic flows may be referred to herein as a traffic aggregate.

At least one of the following may apply. In some embodiments, each of the group of traffic flows may traverse a group of microservices. In some embodiments, each of the one or more ongoing communication sessions may be a PDU session. In some embodiments, each of the group of traffic flows having a similar requirement for quality of service or experience may be a traffic aggregate. In some embodiments, the one or more ongoing communication sessions may be handled by a service mesh (SM).

The one or more first indications may also indicate, for each respective group of traffic flows in each of the one or more ongoing communication sessions having similar requirement for quality of service or experience, at least one of the following options. As a first option, i) a respective pair of nodes, e.g., UPFs, estimated to be required for the shift to handle the respective group of traffic flows. The respective pair of nodes may comprise a respective source node in the source domain 121 and a respective target node in the target domain 122. In some embodiments, each of the nodes in the respective pair of nodes may be one of: a) a Protocol Data Unit (PDU) session anchor, b) a node managing a user plane, and c) a UPF.

Each respective pair of nodes may correspond to a respective pair of core mobile networks and to a respective pair of service meshes (SMs).

As a second option, ii) a respective first priority in handling the shift. As a third option, iii) a first respective time budget requirement for the shift. A time budget requirement may be understood as a desired time interval denoting the time within which the traffic shift may need to be completely executed, so that the quality of experience may not be significantly degraded, e.g., with respect to a threshold. As a fourth option, iv) a first respective load per respective pair of nodes. As a fifth option, v) a second respective load to be shifted, per respective pair of nodes. As a sixth option vi) a first feasible migration budget, per respective pair of nodes. A feasible migration budget may be understood to as an actual or estimated delay that may be fulfilled per respective pair of nodes in order to complete the traffic shifting process. The first feasible migration budget may be understood as a first feasible migration budget, feasible to the first communications network 101.

The obtaining of the one or more first indications may be performed by receiving the one or more first indications, e.g., via the first link 151.

### Action 202

In this Action 202, the first node 111 determines, for each respective group of traffic flows, in each of the one or more ongoing communication sessions having a similar requirement for quality of service or experience, a respective correspondence between a respective first set of resources belonging to the first communications network 101 and a respective second set of resources belonging to the second communications network 102 estimated to be required for the shift. The first set of resources comprises a respective pair of core mobile networks, comprising one or more source mobile networks and one or more target mobile networks. The second set of resources comprises a respective pair of service meshes (SMs), comprising a source service mesh and a target service mesh.

Several functionalities may be built on the assumption that traffic may be categorized into groups of traffic flows, also referred to herein as Traffic Aggregates (TA), which may share similar QoS requirements, hence similar migration budget. Sharing QoS requirements may be understood to basically mean that these groups of traffic flows may share the same user-plane in the first communications network 101. It may also be assumed that each or DN, has an ingress or edge gateway that may enable external connectivity and it may have associated a set of SMs. As stated earlier, a DN may be understood as an IP network external to a mobile network, but which may connect to it.

The first node 111 may, in this Action 202, perform a traffic shifting association and aggregation. That is, the first node 111 may identify all core mobile networks that may be associated to the groups of traffic flows that may be requiring to be shifted, together with the associated Service Meshes (SM) in the second communications network 102, for both the source domain 121, and the target domain 122. These SMs may be the ones that may be involved in the traffic shifting process requiring to be notified about the event.

In this Action 202, the first node 111 also determines, for each respective group of traffic flows, in each of the one or more ongoing communication sessions having a similar requirement for quality of service or experience, a respective priority in the shift for each respective pair of resources. The first node 111 may also estimate an aggregated priority score per core mobile network, based on the individual priority scores associated to each group of traffic flows to be shifted.

The determining in this Action 202 of the respective correspondence and the respective priority may be based on the obtained one or more first indications.

In this Action 202, the first node 111 may determine a mapped traffic aggregate model. That is, the first node 111 may build a representation mapping of the groups of traffic flows, e.g., the Tas, with the second communications network 102 serving the moving device 130. Note that in this case, only Traffic Aggregates with shift_traffic parameter may be set to True. In a non-limiting example, wherein each group of traffic aggregates may be referred to as a TA, such a mapped traffic aggregate model may be expressed as:

| | |
|---|---|
| Mapped | Associated Traffic Aggregates may be then mapped to the edge cloud |
| Traffic | domain and grouped based on common Data Networks they may be served |
| Aggregates | by for both source domain 121, and target domain 122, DN_s and DN_t. |
| | Both source and target domains may be modeled as following: |
| | TAs: Set of tuples containing Traffic Aggregate identifiers together |
| | with their individual priority_scores. Note that this set of Traffic |
| | Aggregates may be only the ones being served via the related DN. |
| | It may be expressed as { (TA_id1, priority_score_1), ..., (TA_idm, |
| | priority_score_m) }. |
| | ServiceMeshes: Set of service meshes associated to each TA { |
| | SM_1, ..., SM_n }. This may represent the set of service meshes |
| | that may be serving different Traffic Aggregates from the moving |
| | device 130. |
| | aggregated_priority_score: may be understood to estimate an |
| | aggregated score for all associated Traffic Aggregate identifiers |
| | based on their single priority_scores. |

UPF_id −> { DN_1, ..., DN_p}: Mapping UPF to all Data Networks connected to it.
DN_id −> {SM_1, ..., SM_n}: Mapping Data Network to all Service Meshes associated to
it.
MC_id −> {SM_1, ... SM_j}: Mapping of the service meshes hosting microservice instances
that form part of a microservice chain.

### Action 203

In this Action 203, the first node 111 provides one or more second indications to the third node 113. The one or more second indications may be based on the obtained one or more first indications.

The first node 111 may help performing alignment and coordination of traffic differentiation (TD) mechanisms by propagating information regarding how to mark and classify traffic flows into Traffic Aggregates in the second communications network 102, e.g., the service mesh-based edge cloud, in alignment with the mechanism in the first communications network 101, e.g., the mobile network. These Traffic Aggregates may have associated certain identifiers that may be related to the ones in the first communications network 101 and may also propagate minimum configuration information among the domains with minimum to no disclosure of end-user's private information.

The providing, e.g., sending, may be performed e.g., via the second link 152.

### Action 204

In this Action 204, the first node 111 may obtain, for each respective group of traffic flows having the similar requirement for quality of service or experience, from the first communications network 101, the first feasible migration budget feasible to the first communications network 101. From the second communications network 102, the first node 111 may obtain in this Action 204, a second migration budget feasible to the second communications network 102.

### Action 205

In this Action 205, the first node 111 determines a distribution of a time budget for the shift, between the first communications network 101 and the second communications network 102. The first node 111 performs this, by exchanging communications with each of the first communications network 101 and the second communications network 102. The determining in this Action 205 of the distribution of the time budget is based on the respective pair of core mobile networks, the respective pair of service meshes and the respective priority, according to a respective end to end performance requirement for the shift. The end to end performance requirement may be understood to be part of the overall QoS requirement and may contribute to determining it.

The determining in this Action 205 of the distribution of the time budget may be further based on, the obtained first feasible migration budget and the obtained second migration budget.

In this Action 205, the first node 111 may perform a time budget distribution negotiation. This may be performed by the first node 111 allowing the distribution of the migration budget between the first communications network 101 and the second communications network 102, e.g., source and target UPFs->source and target DNs->source and target SMs, based on the available end-to-end migration budget and the feasible migration budget in the first communications network 101.

The first node 111 may be understood as a node which may operate in an inter-domain stratum, which may be understood as the stratum handling the interactions between the first communications network 101 and the second communications network 102 domains. In order to perform this Action 205, the first node 111 may keep a mapping representation between the topology of the first communications network 101 and the second communications network 102, e.g., as a result of having performed Action 202 and Action 204. In a non-limiting example, wherein each node in the pair of nodes may be a UPF, and each group of traffic aggregates may be referred to as a TA, such a mapped infrastructure model may be expressed as: The first node 111 may also keep a mapped application model, that is, mapping representation between the Service Data Flows (SDF) that may have been instantiated in the first communications network 101, and the microservice chains that may have been instantiated in the second communications network 102. The first node 111 may also keep track of the service meshes hosting the microservice instances that may form part of a microservice chain (MC).

In a non-limiting example, this may be represented as:

SDF_id/QF_id −> MC_id: Mapping between the Service Data Flow or
QoS Flow in the mobile network and the Microservice Chain in the service
mesh -based edge cloud.

### Action 206

In this Action 206, the first node 111, provides one or more indications to at least one of: the second node 112 operating in the first communications network 101 and the third node 113 operating in the second communications network 102. The one or more indications indicate the determined distribution in Action 205. The provided one or more indications may be understood to be one or more third indications.

The providing, e.g., sending in this Action 206, may be performed e.g., via the first link 151 or the second link 152.

In this Action 206, the first node 111 may perform a traffic shifting notification preparation. That is, the first node 111 may prepare an aggregated notification of the traffic shifting event and the associated priority information for each core mobile network, regarding the groups of traffic flows to be shifted. The first node 111 may perform a traffic shifting priority and notification transmission. Based on the discovery information associated to the core mobile network, the first node 111 may send aggregated traffic shifting notification and associated priorities to each core mobile network by scheduling the notification based on the aggregated priority scores associated to each core mobile network.

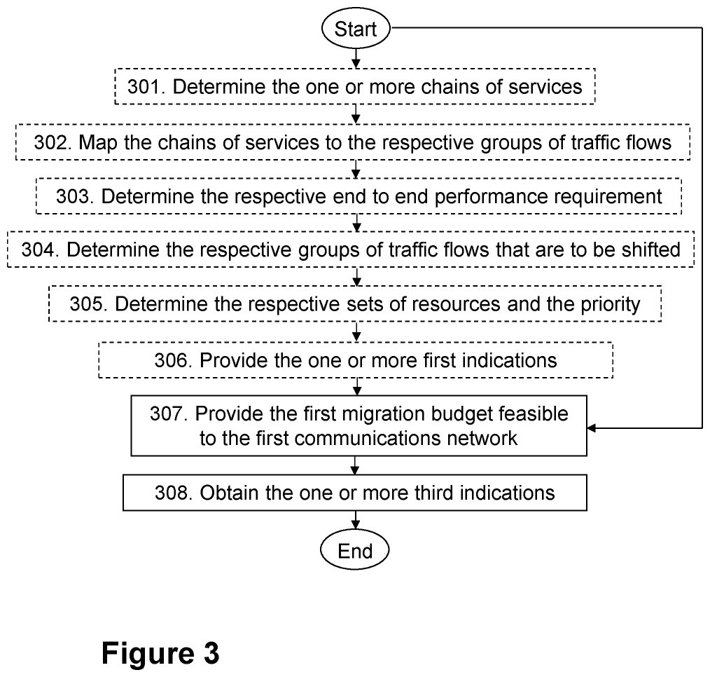

Embodiments of a computer-implemented method, performed by the second node 112, will now be described with reference to the flowchart depicted in FIG. 3. The method may be understood to be for handling the mobility of the one or more ongoing communication sessions for the device 130, from the source domain 121 to the target domain 122. Each of the source domain 121 and the target domain 122 comprises at least the first communications network 101 and the second communications network 102. Each of the one or more ongoing communication sessions comprises the respective group of traffic flows having the respective requirement for a quality of service or experience. The second node 112 operates in the first communications network 101.

As stated earlier, the first communications network 101 may be a mobile network and the second communications network 102 may be an edge cloud network.

The method may comprise the actions described below. In some embodiments all the actions may be performed. In some embodiments some of the actions may be performed. In FIG. 3, optional actions are indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

The detailed description of some of the following corresponds to the same references provided above, in relation to the actions described for the first node 111 and will thus not be repeated here to simplify the description. For example, a group of traffic flows may be referred to herein as a traffic aggregate.

In FIG. 3, optional actions are represented with dashed boxes.

### Action 301

In this Action 301, the second node 112 may determine, from all services in each of the one or more ongoing communication sessions for the device 130, one or more chains of services having a requirement to be performed in a respective sequence over time.

A service may be understood as a piece of software accessible via its networking interface. The software may be a decoupled application component implementing certain logic that may be consumed by an end user e.g., a microservice hosted in edge cloud.

### Action 302

In this Action 302, the second node 112 may map the determined one or more chains of services to the respective group of traffic flows having the respective requirement for the quality of service or experience.

In this Action 302, the second node 112 may perform a multi-level traffic differentiation control and enforcement. The first communications network 101 may perform multi-level differentiation of traffic flows based on UE session management and QoS related information. That is, traffic flows may be differentiated based on configuration from the user-plane of the first communications network 101, such as PDU sessions, QoS Flows, and/or SDFs. The first communications network 101 may perform marking and classification of traffic, and apply differentiated traffic steering strategies based on the traffic's associated QoS rules.

The second node 112 may, in this Action 302, perform a multi-level traffic association and aggregation by identifying consumed microservice chains and how they may be associated to the different elements part of the user-plane of the device 130, e.g., PDU sessions, Data Radio Bearers (DRBs), QoS flows, SDFs, among others.

### Action 303

In this Action 303, the second node 112 may determine a respective end to end performance requirement for each of the determined respective group of traffic flows.

In this Action 302, the second node 112 may perform a performance constraint retrieval. That is, the second node 112 may retrieve end-to-end performance requirements and/or constraints associated to each group of traffic flows. Examples of performance constraints may be expected latency and bandwidth.

### Action 304

In this Action 304, the second node 112 may determine the respective group of traffic flows in each of the one or more ongoing communication sessions having the similar respective requirement for quality of service or experience, that are to be shifted from the source domain 121 to the target domain 122, and

In this Action 304, the second node 112 may perform a traffic shifting evaluation. That is, the second node 112 may evaluate and identify all associated groups of traffic flows that may be requiring to be shifted by e.g., comparing the expected performance vs. the actual performance. The actual performance may be measured, estimated and/or predicted. Upon determining what groups of traffic flows may require migration, this function may also identify associated PSAs and UPFs involved in the traffic shifting, both source domain 121 and target domain 122.

### Action 305

In this Action 305, the second node 112, may determine, for each of the determined respective group of traffic flows, and based on the respective requirement for the quality of service or experience, at least one of the following options. As a first option, i) the respective pair of nodes estimated to be required for the shift to handle the respective group of traffic flows. The respective pair of nodes may comprise the respective source node in the source domain 121 and the respective target node in the target domain 122. As a second option, ii) the respective first priority in handling the shift. As a third option, iii) the first respective time budget requirement for the shift. As a fourth option, iv) the first respective load per respective pair of nodes. As a fifth option, v) the second respective load to be shifted, per respective pair of nodes. As a sixth option, vi) the first feasible migration budget, per respective pair of nodes.

The determining of the respective first priority may be based on the determined respective end to end performance requirement in Action 303. For the second option, in this Action 305, the second node 112 may perform a traffic shifting prioritization. That is, the second node 112 may rank groups of traffic flows based on the associated migration budget, and assign a priority score which may e.g., be in the range 0-10, where 10 represents the highest priority.

For the third option, in this Action 305, the second node 112 may perform a time budget requirement estimation and/or retrieval. This function may allow the first communications network 101 to estimate or retrieve the end-to-end migration budget associated to each group of traffic flows. This migration budget may be expressed as the acceptable delay time during the traffic shifting process.

For the fourth option, in this Action 305, the second node 112 may perform a traffic load dimensioning. That is, the second node 112 may estimate or predict the total ongoing or future traffic load in the pair of UPFs associated to the group of traffic flows, e.g., UPF in the source domain 121, and UPF in the target domain 122. Note that this estimation may consider all groups of traffic flows and UEs being served by each UPFs, and not limited to the associated group of traffic flows or UE.

For the fifth option, in this Action 305, the second node 112 may perform a traffic shifting load dimensioning. That is, the second node 112 may estimate or predict the load of the ongoing or future traffic that may be requiring to be shifted in the pair of UPFs associated to the group of traffic flows, e.g., the source domain 121, and UPF in the target domain 122.

For the sixth option, in this Action 305, the second node 112 may perform a feasible time budget estimation. That is, the second node 112 may estimate or predict a feasible migration budget for the associated group of traffic flows. For that, the second node 112 may consider the traffic shifting priority score associated to the group of traffic flows and/or the associated migration budget vs. the total traffic load and the load of the traffic to be shifted in the associated nodes, e.g., UPFs.

In this Action 305, the second node 112 may determine a total traffic and traffic aggregate model. These models may be built and may only be available in the domain of the first communications network 101 as a way to represent total traffic and groups of traffic flows.

In a non-limiting example, wherein each node in the pair of nodes may be a UPF, the device 130 may be a UE, and each group of traffic aggregates may be referred to as a TA, such a mapped infrastructure model may be expressed as:

| | |
|---|---|
| Total | Denoted as TT, may be understood to represent |
| Traffic | the total traffic flow aggregate associated to the |
| | moving UE. It may include information such as: |
| | UE_id: Identifier of the user equipment. |
| | {TA_QoS1, . . . , TA_QoSi}: Set of Traffic |
| | Aggregates grouped based on equal/similar |
| | expected quality of service. |
| Traffic | Each Traffic Aggregate denoted by TA_QoSi |
| Aggregate | may be modeled based on the following |
| | information: |
| | TA_id: Identifier associated to the traffic |
| | aggregate. |
| | UserPlane_s: A representation of the different |
| | elements part of the user-plane associated to the |
| | moving UE in the source domain 121. It may |
| | include identifiers such as |
| | {PDUSession_s_id, DRB_s_id, |
| | QoSFlow_s_id, SDF_s_id, PSA_s_id, |
| | UPF_s_id. DN_s_id}. |
| | UserPlane_t: A representation of the different |
| | elements part of the user-plane associated to the |
| | moving UE in the target domain 122. It may |
| | include identifiers such as {PDUSession_t_id, |
| | DRB_t_id, QoSFlow_t_id, SDF_t_id, |
| | PSA_t_id, UPF_t_id, DN_t_id}. |
| | QoS_reqs: A collection of information related |
| | to the parameters describing the expected quality |
| | of service associated to the Traffic Aggregate. |
| | It may be expressed as for example {latency, |
| | bandwidth, etc.}. |
| | migration_budget: may be understood to |
| | represent the acceptable delay caused by the |
| | migration process which may not be |
| | perceived by the end-user. |
| | shift_traffic: may be understood as a |
| | recormmendation given by the system regarding |
| | shifting or not the related Traffic Aggregate. It |
| | may be expressed as a Boolean value True \| |
| | False. |
| | priority_score: may be understood as a score |
| | representing the priority of the traffic shifting |
| | process for the associated Traffic Aggregate. It |
| | may be for example expressed in the range [0, 10], |
| | where 10 represents the highest priority. |

UPF Tuple −> (UPF_id_s, UPF_id_t): may be understood to represent
the UPF in the source and the target domain associated to each Traffic
Aggregate.
total_traffic_load: Score representing the total traffic load over a UPF
tuple for all Traffic Aggregates and UEs served. It may be expressed
in the scale [0, 100] where 100 means full load.
traffic_shifting_load: Score representing the traffic load over a
UPF tuple for all Traffic Aggregates that may be needed to be
shifted and for all simultaneous moving UEs. It may be expressed
in the scale [0, 100] where 100 represents full load.
feasible_migration_budget: Current feasible migration budget, e.g.,
delay, per UPF tuple for performing traffic shifting.

### Action 306

In this Action 306, the second node 112 may provide the one or more first indications to the first node 111. The one or more first indications may indicate at least one of the following. In some embodiments, the one or more indications may indicate the respective group of traffic flows in each of one or more ongoing communication sessions, that is, ongoing communications sessions for the device 130, that are to be shifted from the source domain 121 to the target domain 122.

In some embodiments, the one or more first indications may, alternatively, or additionally, indicate, for each respective group of traffic flows in each of the one or more ongoing communication sessions having similar requirement for quality of service or experience, the determined at least one of the following. As a first option, i) the respective pair of nodes, e.g., UPFs, estimated to be required for the shift to handle the respective group of traffic flows. The respective pair of nodes may comprise the respective source node in the source domain 121 and the respective target node in the target domain 122.

As a second option, ii) the respective first priority in handling the shift. As a third option, iii) the first respective time budget requirement for the shift. As a fourth option, iv) the first respective load per respective pair of nodes. As a fifth option, v) the second respective load to be shifted, per respective pair of nodes. As a sixth option vi) the first feasible migration budget, per respective pair of nodes.

At least one of the following may apply. In some embodiments, each of the group of traffic flows may traverse a group of microservices. In some embodiments, each of the one or more ongoing communication sessions may be a PDU session. In some embodiments, each of the group of traffic flows having a similar requirement for quality of service or experience may be a traffic aggregate. In some embodiments, the one or more ongoing communication sessions may be handled by a service mesh (SM).

In some embodiments, each of the nodes in the respective pair of nodes may be one of: a) a PDU session anchor, b) a node managing a user plane, and c) a UPF.

Each respective pair of nodes may correspond to a respective pair of core mobile networks and to a respective pair of service meshes (SMs).

### Action 307

In this Action 307, the second node 112, provides, to the first node 111 operating in at least one of the first communications network 101, the second communications network 102, and the another communications network 103, for each respective group of traffic flows in each of the one or more ongoing communication sessions having a similar requirement for quality of service or experience, the first feasible migration budget feasible to the first communications network 101.

The providing, e.g., sending, may be performed e.g., via the first link 152.

### Action 308

In this Action 308, the second node 112 obtains, from the first node 111, the one or more third indications. The one or more third indications indicate, for each respective group of traffic flows in each of the one or more ongoing communication sessions that are to be shifted from the source domain 121 to the target domain 122, each of the respective group of traffic flows having the similar requirement for quality of service or experience, the distribution of the time budget for the shift between the source domain 121 and the target domain 122. The obtained distribution of the time budget is based on the provided first feasible migration budget feasible to the first communications network 101, and the respective end to end performance requirement for the shift.

The obtained distribution of the time budget for the shift may be further based on, for each respective group of traffic flows, in each of the one or more ongoing communication sessions having the similar requirement for quality of service or experience, the respective correspondence. The respective correspondence may be between the respective first set of resources belonging to the first communications network 101 and the respective second set of resources belonging to the second communications network 102 estimated to be required for the shift. The first set of resources comprises the respective pair of one or more source core mobile networks and one of one or more target mobile networks. The second set of resources may comprise the respective pair of service meshes, comprising the source service mesh and the target service mesh.

The obtained distribution of the time budget for the shift may be further based on, for each respective group of traffic flows, in each of the one or more ongoing communication sessions having the similar requirement for quality of service or experience, the respective priority in the shift for each respective pair of resources.

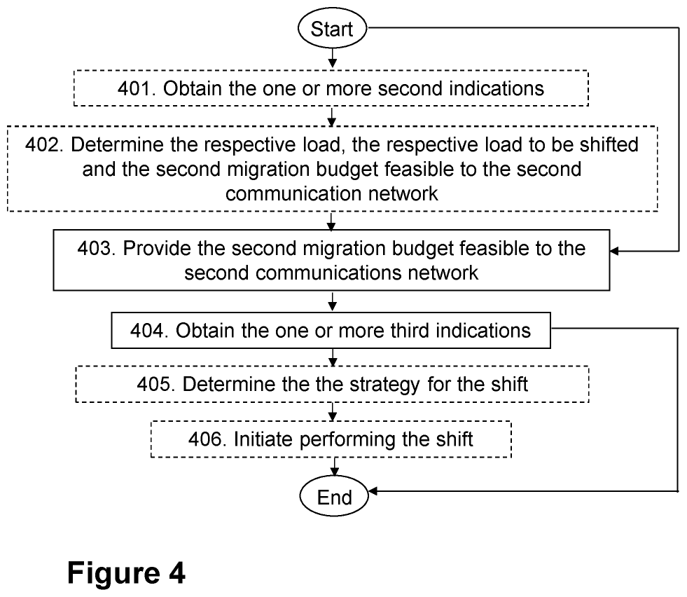

Embodiments of a computer-implemented method performed by the third node 113, will now be described with reference to the flowchart depicted in FIG. 4. The method may be understood to be for handling the mobility of the one or more ongoing communication sessions for the device 130, from the source domain 121 to the target domain 122. Each of the source domain 121 and the target domain 122 comprises at least the first communications network 101 and the second communications network 102. Each of the one or more ongoing communication sessions comprises the respective group of traffic flows having the respective requirement for the quality of service or experience. The third node 113 operates in the second communications network 102.

As stated earlier, the first communications network 101 may be a mobile network and the second communications network 102 may be an edge cloud network.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are depicted with dashed lines.

The detailed description of some of the following corresponds to the same references provided above, in relation to the actions described for the first node 111 and will thus not be repeated here to simplify the description. For example, a group of traffic flows may be referred to herein as a traffic aggregate.

### Action 401

In this Action 401, the third node 113 may obtain the one or more second indications from the first node 111. The one or more second indications may indicate, for each respective group of traffic flows in each of the one or more ongoing communication sessions that are to be shifted from the source domain 121 to the target domain 122 having the similar requirement for quality of service or experience, at least one of the following options. In a first option, i) the respective first set of resources in the first communications network 101 estimated to be required for the shift. In a second option, ii) the respective second set of resources in the second communications network 102 estimated to be required for the shift. In a third option, iii) the respective first priority in handling the shift.

The respective first set of resources may comprise at least one of the following. As a first option, i) the respective pair of nodes, e.g., UPFs, estimated to be required for the shift to handle the respective group of traffic flows. The respective pair of nodes may comprise the respective source node in the source domain 121 and the respective target node in the target domain 122.

As a second option, ii) the respective first priority in handling the shift. As a third option, iii) the first respective time budget requirement for the shift. As a fourth option, iv) the first respective load per respective pair of nodes. As a fifth option, v) the second respective load to be shifted, per respective pair of nodes. As a sixth option vi) the first feasible migration budget, per respective pair of nodes.

At least one of the following may apply. In some embodiments, each of the group of traffic flows may traverse a group of microservices. In some embodiments, each of the one or more ongoing communication sessions may be a PDU session. In some embodiments, each of the group of traffic flows having a similar requirement for quality of service or experience may be a traffic aggregate. In some embodiments, the one or more ongoing communication sessions may be handled by a service mesh (SM).

In some embodiments, each of the nodes in the respective pair of nodes may be one of: a) a PDU session anchor, b) a node managing a user plane, and c) a UPF.

Each respective pair of nodes may correspond to a respective pair of core mobile networks and to a respective pair of service meshes (SMs).

### Action 402

In this Action 402, the third node 113 may determine, for each pair of respective service meshes: i) the respective load, ii) the respective load corresponding to the traffic to be shifted, and iii) the second migration budget feasible to the second communications networks 102. The second migration budget may be determined based on the determined respective load and the respective load corresponding to the traffic to be shifted.

Determining may be understood as e.g., calculating or deciding.

To determine the respective load, the third node 113 may perform traffic load dimensioning. That is, the third node 113 may estimate or predict the total ongoing or future traffic load in the pair of SMs associated to the respective group of traffic flows, e.g., SM(s) in the source domain 121 and SM(s) in target domain 122. Note that this estimation may consider all groups of traffic flows and UEs being served by each SM, and not limited to the associated group of traffic flows or UE.

To determine the respective load corresponding to the traffic to be shifted, the third node 113 may perform traffic shifting dimensioning. That is, the third node 113 may estimate or predict the load of the ongoing or future traffic requiring to be shifted in the pair of SMs associated to the respective group of traffic flows, e.g., SM(s) in the source domain 121 and SM(s) in target domain 122.

To determine the second migration budget feasible to the second communications networks 102, the third node 113 may perform traffic shifting time budget estimation. That is, the third node 113 may estimate or predict a feasible migration budget, that is, an acceptable delay for traffic shifting, in the second communications network 102 for the associated group of traffic flows, and for each of the available traffic shifting strategies. For that, the third node 113 may consider the traffic shifting priority score associated to the respective group of traffic flows, and/or the associated migration budget vs. the total traffic load, the load of the traffic to be shifted in the associated SMs and the type of traffic shifting strategy.

In a non-limiting example, the following mapped infrastructure model may apply:

DN Tuple −> (DN_id_s, DN_id_t): may be understood to represent the DNs in the source
and target domains associated to each Traffic Aggregate. Note that a source or target DN
may be composed by one or more DNs.
SM Tuple −> (SM_id_s, SM_id_t): may be understood to represent the SMs in the source
and target domains associated to each Traffic Aggregate. Note that a source or target SM
may be composed by one or more SMs.
total_traffic_load: Score representing the total traffic load over a SM tuple for all Traffic
Aggregates and UEs served. It may be expressed in the scale [0, 100] where 100 means
fully load.
{(tss_1, feasible_migration_budget), ..., (tss_r, feasible_migration_budget)}: List of tuples
representing the different traffic shifting strategies available in a SM tuple, such as
constant traffic mirroring, gradual traffic mirroring, constant traffic splitting, gradual traffic
splitting, among others, plus the currently estimated feasible migration budget per SM
tuple for performing traffic shifting.

### Action 403

In this Action 403, the third node 113 may provide, to the first node 111 operating in at least one of the first communications network 101, the second communications network 102, and the another communications network 103, for each respective group of traffic flows in each of the one or more ongoing communication sessions having a similar requirement for quality of service or experience, the second migration budget feasible to the second communications network 102.

The provided second migration budget may be based on the obtained one or more second indications in Action 401.

### Action 404

In this Action 404, the third node 113 obtains, from the first node 111, the one or more third indications. The one or more third indications indicate, for each respective group of traffic flows in each of the one or more ongoing communication sessions that are to be shifted from the source domain 121 to the target domain 122, each of the respective group of traffic flows having the similar requirement for quality of service or experience, the distribution of the time budget for the shift between the first communications network 101 and the second communications network 102. The obtained distribution of the time budget is based on the provided second migration budget feasible to the second communications network 102.

### Action 405

In this Action 405, the third node 113 may determine, based on the obtained one or more third indications, and available resources at the second communications network 102, as estimated by the third node 113, a strategy for the shift.

The determined strategy for the shift may be further based on the determined respective load, the respective load corresponding to the traffic to be shifted, and the respective first priority.

In this Action 405, the third node 113 may perform an optimized selection of traffic shifting strategy. That is, the third node 113 may, based on the list of migration budgets associated to each of the available traffic shifting strategies, select the most reliable traffic shifting strategy that may fulfil the end-to-end migration budget for each group of traffic flows, based on the feasible migration budget in the first communications network 101 and in the second communications network 102.

### Action 406

In this Action 406, the third node 113 may initiate performing the shift, based on the determined strategy in Action 405.

In this Action 406, the third node 113 may perform a traffic shifting priority and notification reception. Each DN may receive the notification from the first node 111 and forward the information in order based on the associated priority scores, that is, the notification is propagated first to those with high priority scores.

In this Action 406, the third node 113 may also perform a traffic shifting priority configuration. That is, the third node 113 may update priority-related configuration in each associated service mesh, e.g., for components in both control plane and data plane (DP), for scheduling the efficient execution of the traffic shifting based on associated priorities.

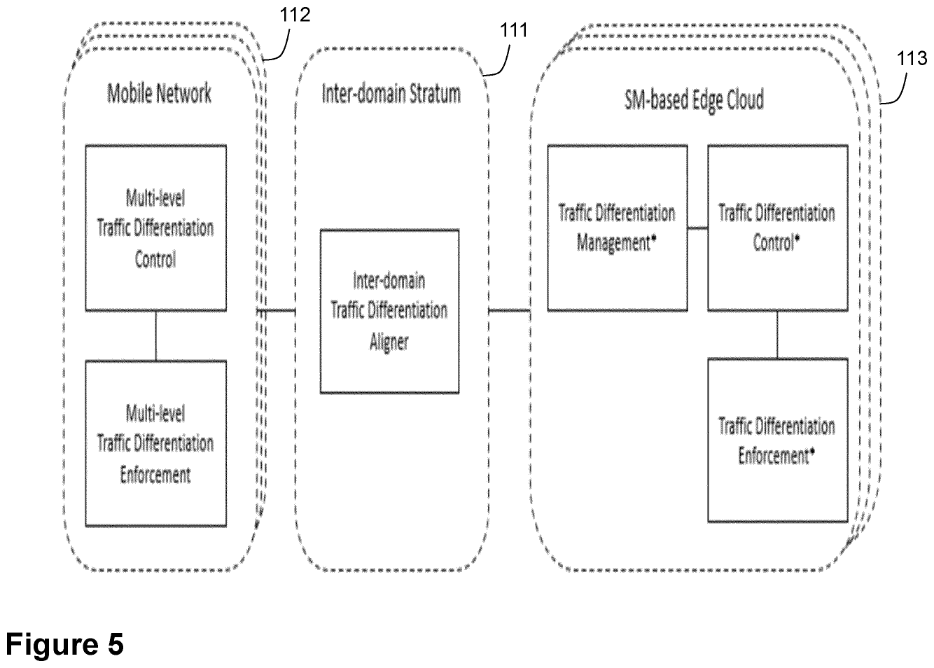

FIG. 5 is a schematic diagram depicting aspects of an aligned traffic differentiation: system, according to embodiments herein. In this non-limiting example, the first communications network 101 is a mobile network, the second communications network 102 is a service mesh-based edge cloud network, and the other communications network 103 provides connectivity to an inter-domain stratum. FIG. 5 schematically depicts the high-level context and assumptions that may be used as baselines for aligning the traffic differentiation mechanism between the mobile network and the service mesh-based edge cloud. Based on this aligned traffic differentiation mechanism, a system and method for converged traffic shifting procedure upon UE-mobility events may be performed according to embodiments herein. For multi-level traffic differentiation control and enforcement, the mobile network may perform multi-level differentiation of traffic flows based on UE session management and QoS related information, e.g., traffic flows may be differentiated based on configuration from the mobile network's user-plane such as PDU sessions, QoS Flows, SDFs. The mobile network may perform marking and classification of traffic and apply differentiated traffic steering strategies based on the traffic's associated QoS rules. In the inter-domain traffic differentiation aligner, the inter-domain stratum may help performing alignment and coordination of traffic differentiation mechanisms by propagating information regarding how to mark and classify traffic flows into traffic aggregates in the service mesh-based edge cloud in alignment with the mechanism in the mobile network. These traffic aggregates may have associated certain identifiers that may be related to the ones in the mobile network and may also propagate minimum configuration information among the domains with minimum to no disclosure of end-user's private information. For traffic differentiation management, control and enforcement, the service mesh-based edge cloud may perform differentiation of traffic flows based on traffic aggregates mapped from the mobile network, e.g., traffic aggregates identifiers and configuration information. The service meshes may perform marking and classification of traffic and apply differentiated traffic steering strategies based on the configuration rules associated to the traffic aggregate's identifiers.

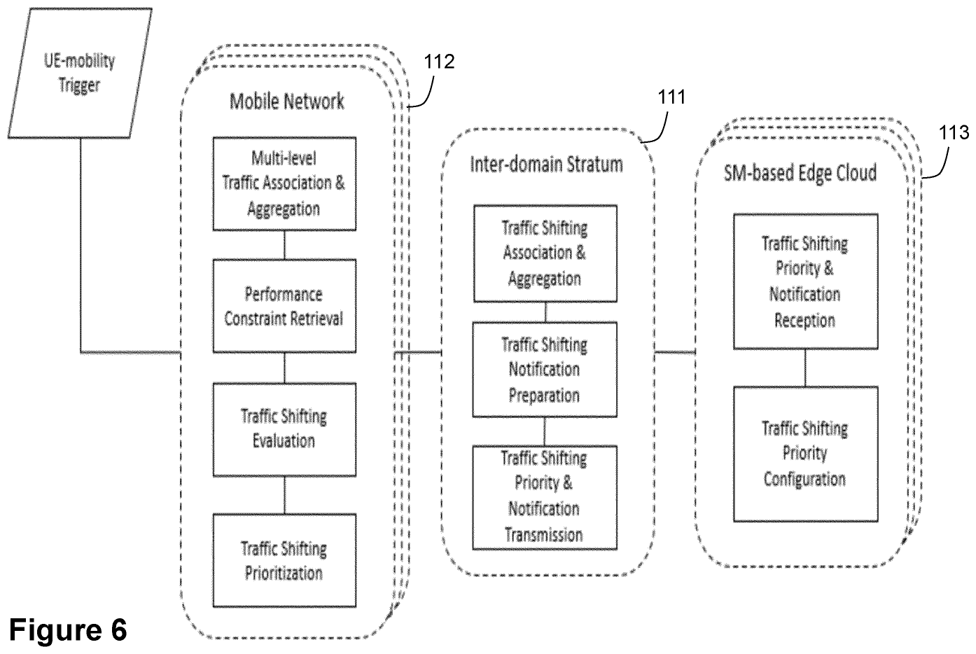

FIG. 6 is a schematic diagram depicting aspects of an efficient inter-domain traffic shifting signaling system, according to embodiments herein. In this non-limiting example, the first communications network 101 is a mobile network, the second communications network 102 is a service mesh-based edge cloud network, the first node 111 operates in an inter-domain stratum, and the device 130 is a UE. FIG. 6 schematically depicts the efficient signaling between the mobile network and the edge cloud domains that may be related to traffic shifting events, e.g., upon UE-mobility trigger. The main trigger considered is the UE-mobility associated event, which may be somehow signalled, predicted or deduced by the mobile network. Several functionalities may be built on the assumption that traffic may be categorized into Traffic Aggregates (TA) which may share similar QoS requirements, hence similar migration budget. Sharing QoS requirements may be understood to mean that these TAs may share the same mobile network's user-plane. It may also be assumed that each DN may have an ingress or edge gateway that may enable external connectivity, and it may have associated a set of Service Meshes. The mobile network may keep track of the identifier associated to the moving UE and, based on that, may perform the following functions. As a first function, multi-level traffic association and aggregation. The mobile network may identify consumed microservice chains and how they may be associated to the different elements part of the UE's user-plane, e.g., PDU sessions, DRBs, QoS flows, SDFs, among others. As a first function, performance constraint retrieval. The mobile network may retrieve end-to-end performance requirements and/or constraints associated to each TA. Examples of performance constraints may be expected latency and bandwidth. As a third function, traffic shifting evaluation. The mobile network may evaluate and identify all associated TA that may be requiring to be shifted by e.g., comparing the expected performance vs. the actual performance. The actual performance may be measured, estimated and/or predicted. Upon determining what TAs may require migration, this function may also identify associated PSAs and UPFs involved in the traffic shifting, both source domain 121 and target domain 122. As a fourth function, traffic shifting prioritization. The mobile network may rank TAs based on the associated migration budget, and assign a priority score which may e.g., be in the range 0-10, where 10 represents the highest priority.

The inter-domain stratum may perform the following functions. As a first function, the inter-domain stratum may perform traffic shifting association and aggregation. The inter-domain stratum may identify all Data Networks (DN) that may be associated to the TAs that may be requiring to be shifted together with the associated Service Meshes (SM) in the edge cloud, for both source domain 121 and target domain 122. These SMs may be the ones that may be involved in the traffic shifting process that may be requiring to be notified about the event. The inter-domain stratum may also estimate an aggregated priority score, per DN, based on the individual priority scores associated to each TA to be shifted. As a second function, the inter-domain stratum may perform traffic shifting notification preparation. The inter-domain stratum may prepare aggregated notification of the traffic shifting event, and associated priority information for each DN regarding the TAs to be shifted. As a third function, the inter-domain stratum may perform traffic shifting priority and notification transmission. Based on discovery information associated to the DN, the inter-domain stratum may send aggregated traffic shifting notification and associated priorities to each DN by scheduling the notification based on the aggregated priority scores associated to each DN.

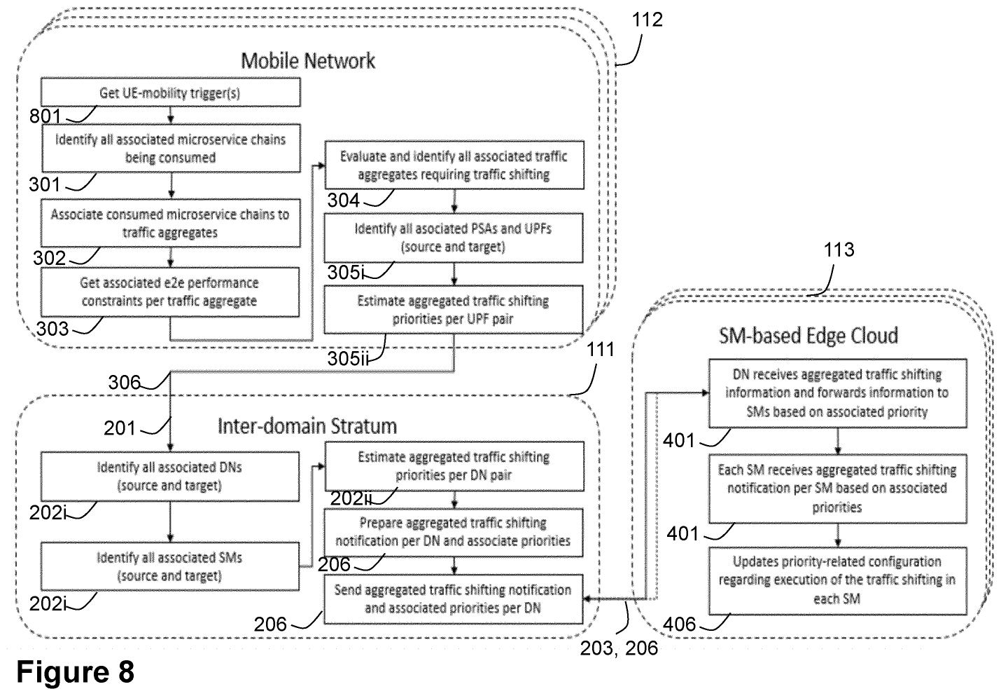

The service mesh—based edge cloud may perform the following functions. As a first function, the service mesh—based edge cloud may perform traffic shifting priority and notification reception. Each DN may receive the notification from the inter-domain stratum and forward the information in order, based on the associated priority scores. Notification is propagated first to those with high priority score. As a second function, the service mesh—based edge cloud may perform a traffic shifting priority configuration. The inter-domain stratum may update priority-related configuration in each associated service mesh, for components in both control plane and data plane, for scheduling the efficient execution of the traffic shifting based on associated priorities. See the description of FIG. 8 for more details regarding the proposed method for efficient inter-domain traffic shifting signaling.

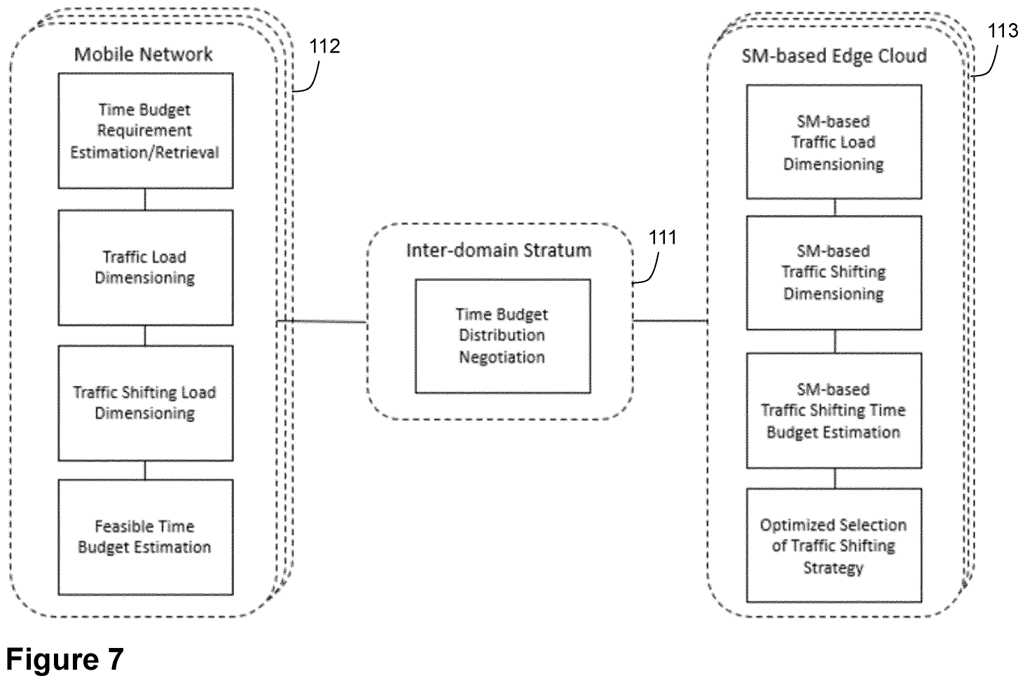

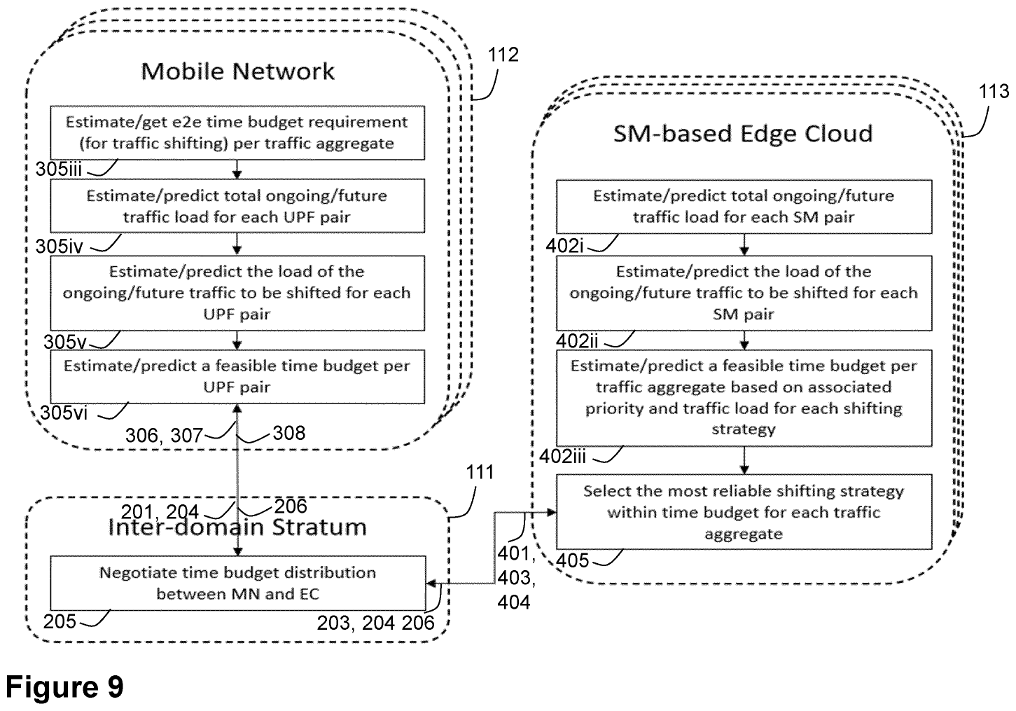

FIG. 7 is a schematic diagram depicting aspects of optimized inter-domain traffic shifting strategy selection that may be performed according to embodiments herein. In this non-limiting example, the first communications network 101 is a mobile network, the second communications network 102 is a service mesh-based edge cloud network, and the other communications network 103 provides connectivity to an inter-domain stratum. FIG. 7 schematically depicts the optimized selection of a traffic shifting strategy in the service mesh-edge cloud. This selected strategy may be based on a dynamic negotiation of the distribution of the migration budget assigned for traffic shifting in alignment with the mobile network, which may be performed according to embodiments herein. The system of FIG. 7 may execute the procedure in FIG. 9 for all TAs requiring to be shifted.

The mobile network may perform the following functions. As a first function, the mobile network may perform time budget requirement estimation and/or retrieval. This function may allow the mobile network to estimate or retrieve the end-to-end migration budget associated to each TA. This migration budget may be expressed as the acceptable delay time during the traffic shifting process. As a second function, the mobile network may perform traffic load dimensioning. The mobile network may estimate or predict the total ongoing or future traffic load in the pair of UPFs associated to the TA, e.g., UPF in source domain 121, and UPF in the target domain 122. Note that this estimation may consider all TAs and UEs being served by each UPFs and not limited to the associated TA or UE. As a third function, the mobile network may perform traffic shifting load dimensioning. The mobile network may estimate or predict the load of the ongoing or future traffic requiring to be shifted in the pair of UPFs associated to the TA, e.g., UPF in source domain 121, and UPF in target domain 122. As a fourth function, the mobile network may perform feasible time budget estimation. The mobile network may estimate or predict a feasible migration budget, that is, an acceptable delay for traffic shifting, in the mobile network for the associated TA. For that, the mobile network may consider the traffic shifting priority score associated to the TA and/or the associated migration budget vs. the total traffic load and the load of the traffic to be shifted in the associated UPFs.

The inter-domain stratum may perform the following functions. As a first function, the inter-domain stratum may perform time budget distribution negotiation. The inter-domain stratum may allow the distribution of the migration budget between the mobile network and the service mesh-based edge cloud, e.g., source and target UPFs->source and target DNs->source and target SMs, based on the available end-to-end migration budget and the feasible migration budget in the mobile network.

The service mesh-based edge cloud may perform the following function. As a first function, the service mesh-based edge cloud may perform traffic load dimensioning. The service mesh-based edge cloud may estimate or predict the total ongoing or future traffic load in the pair of SMs associated to the TA, e.g., SM(s) in source and SM(s) in target domains. Note that this estimation may consider all TAs and UEs being served by each SM and not limited to the associated TA or UE. As a second function, the service mesh-based edge cloud may perform traffic shifting dimensioning. The service mesh-based edge cloud may estimate or predict the load of the ongoing or future traffic requiring to be shifted in the pair of SMs associated to the TA, e.g., SM(s) in source and SM(s) in target domains. As a third function, the service mesh-based edge cloud may perform traffic shifting time budget estimation. The service mesh-based edge cloud may estimate or predict a feasible migration budget, that is, an acceptable delay for traffic shifting, in the service mesh-based edge cloud for the associated TA and for each of the available traffic shifting strategies. For that, the service mesh-based edge cloud may consider the traffic shifting priority score associated to the TA and/or the associated migration budget vs. the total traffic load, the load of the traffic to be shifted in the associated SMs and the type of traffic shifting strategy. As a fourth function, the service mesh-based edge cloud may perform optimized selection of traffic shifting strategy. Based on the list of migration budgets associated to each of the available traffic shifting strategies, the service mesh-based edge cloud may select the most reliable traffic shifting strategy that fulfils the end-to-end migration budget for each TA, based on the feasible migration budget in the mobile network.

FIG. 8 is a schematic diagram depicting aspects of efficient inter-domain traffic shifting signaling that may be performed according to embodiments herein. In this non-limiting example, the first communications network 101 is a mobile network, the second communications network 102 is a service mesh-based edge cloud network, and the other communications network 103 provides connectivity to an inter-domain stratum. FIG. 8 schematically depicts the mechanism provided by embodiments herein for performing efficient traffic shifting signaling across the mobile network and the service mesh-based edge cloud domains based on traffic aggregates, according to the foregoing description, and in the Actions corresponding to the reference numbers indicated. At 801, the mobile network may get the UE-mobility triggers, and may then proceed according to the foregoing description, and in the Actions corresponding to the reference numbers indicated in FIG. 8.

FIG. 9 is a schematic diagram depicting aspects of optimized traffic shifting strategy selection that may be performed according to embodiments herein. In this non-limiting example, the first communications network 101 is a mobile network, the second communications network 102 is a service mesh-based edge cloud network, and the other communications network 103 provides connectivity to an inter-domain stratum. FIG. 9 schematically depicts the mechanism provided by embodiments herein for performing optimized selection of traffic shifting strategy in the service mesh-based edge cloud in alignment with the mobile network domain based on traffic aggregates and source and target tuples associated to the migration. This method may not only be triggered upon UE-mobility event but may also be triggered periodically, according to the foregoing description, and in the Actions corresponding to the reference numbers indicated.

### Non-Limiting Example

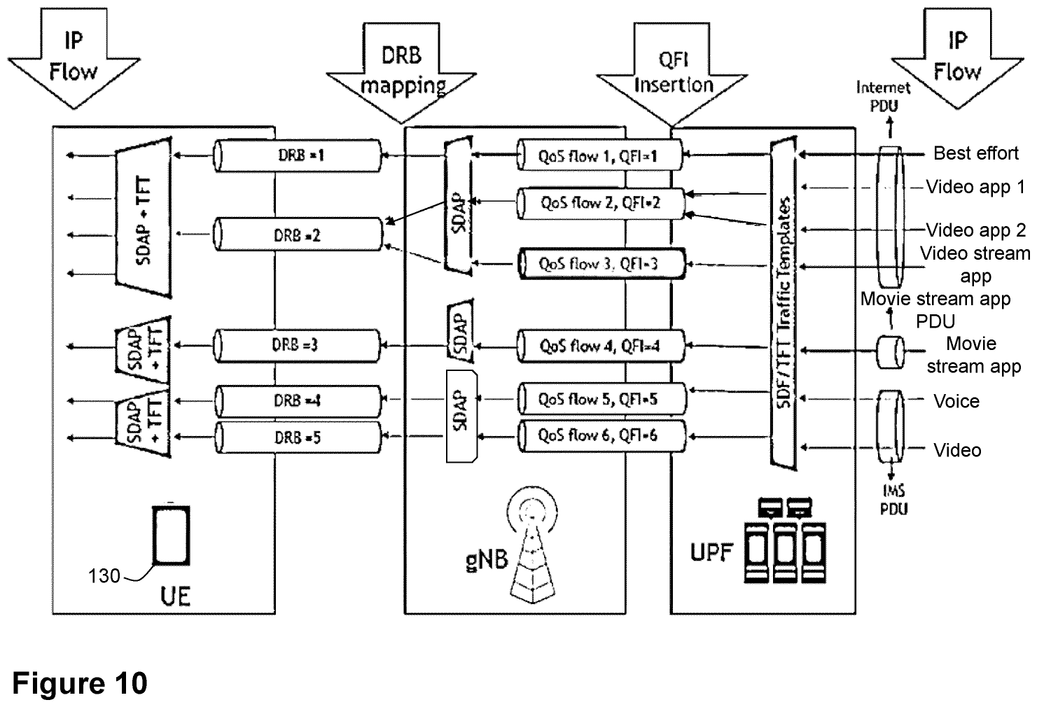

The methods of embodiments herein may be illustrated with a non-limiting example depicted in the schematic diagram of FIG. 10. FIG. 10 schematically depicts PDU Session, QoS Flow and Session Data Flows in the 5G user-plane. As depicted in FIG. 10, an end-user, may consume several applications simultaneously, e.g., listening to music, watching movies, SMS, via the same the device 130, e.g., a UE. These consumed service chains may belong to the same or different applications and may also have different Service Level Agreements (SLAs) or QoE requirements. Thus, they may be served by same/different PDU sessions with same/different PDU session anchors (PSA), same/different QoS flows and different Service Data Flows (SDFs). FIG. 10 also depicts the DRBs part of the 5G radio, and how traffic aggregates may be mapped in different parts of the network, traffic classification filters in the UE and the UPF, insertion of QoS Flow Identifiers (QFI) to the IP flows, among others. In FIG. 10, SDAP indicates Service Data Adaptation Protocol, and TFT indicates Traffic Flow Template. FIG. 10 may be understood to correspond to aspects of Actions 301, 302 and 305.

In the mobile network, traffic steering mechanisms may act or be enforced at the level of Traffic Aggregates. Upon UE-mobility-triggered service migration, there may usually be several PDU sessions, QoS flows and SDFs associated to the moving UE. These different levels of Traffic Aggregates may require an adequate evaluation to identify and decide appropriate traffic shifting strategies in coordination with the edge cloud platform and the edge-cloud hosted application. Then, it may be possible to reduce the signaling by having a migration strategy acting on traffic aggregates, which may consider also the required QoS for prioritization and scheduling of traffic according to the associated migration budget.

It may be considered, for example, a UE consuming two applications. On one hand, a movie streaming application via a movie streaming application provider 1, and comprising the following microservice chains: v1. movie_streaming→movie_playback→movie_caching→movie_storage and v2. movie_search→movie_previewing→view_reviews→enter_review. On the other hand, a music streaming application via a music streaming provider 1 and comprising the following microservice chains: m1. music streaming→music playback→music_caching→music_storage and m2. music_search→music_previewing→view_reviews→enter_review.

Upon UE-mobility-triggered microservice migration, it may be assumed one PDU session with three different QoS Flows, hence three different Traffic Aggregates—TA1 for movie streaming application provider 1 latency-sensitive chain v1, TA2 for music streaming provider 1's latency-sensitive chain m1 and TA3 for the non-latency sensitive chains v2 and m2.

Hence, the system may perform the following identification, association and estimation functions:
Mobile network:
   Identifies all consumed microservice chains: v1, v2, m1 and m2
   Maps consumed microservices chains to traffic aggregates:
      v1→TA1
      m1→TA2
      v2, m2→TA3
   Gets e2e performance constraints per TA:
      TA1: latency: 200 ms
      TA2: latency: 300 ms
      TA3: latency: 1000 ms
   Identifies TAs that may be requiring traffic shifting: Only latency-sensitive ones TA1 and TA2
   Identifies associated UPFs for TA1 and TA2:
      Source domain: UPF1
      Target domain: UPF2
   Estimates traffic shifting priorities per TA:
      TA1: priority10 (higher priority since it is movie streaming related and hence latency sensitive)
      TA2: priority7
   Estimates traffic shifting budget per TA:
      TA1: migration_budget: 100 ms
      TA2: migration_budget: 150 ms
      TA3: migration_budget: 700 ms
   Estimates total traffic load per UPF pair:
      (UPF1, UPF2): 80%->slightly high load
   Estimates the load associated to the traffic to be shifted per UPF pair:
      (UPF1, UPF2): 95%->most of the traffic needs to be shifted
   Estimates a feasible traffic shifting budget per UPF pair:
      (UPF1, UPF2): 60 ms
Inter-domain stratum:
   Identifies the data networks associated with the two TAs above
      TA1: Source UPF1→DN11; target UPF2→DN12
      TA2: Source UPF1→DN21; target UPF2→DN22
   Identifies the associated SMs with the DNs above
      Source DN11→SM11; target DN12→SM12
      Source DN21→SM21; target DN22→SM22
   Estimates traffic shifting priorities per DN pair, with higher priority score given to the movie streaming chain, and medium priority for the music streaming chain
      (DN11, DN12): priority10
      (DN21, DN22): priority7
   Negotiates time budget distribution between mobile network and service mesh-based edge cloud per TA in order to implement migration within the e2e migration budget
      TA1: e2e_migration_budget 100 ms; MN_feasible_migration_budget 60 ms; EC_feasible_migration_budget 40 ms
      TA2: e2e_migration_budget 150 ms; MN_feasible_migration_budget 90 ms; EC_feasible_migration_budget 60 ms
Service mesh-based edge cloud:
   Estimates total traffic load per SM pair:
      (SM11, SM12): 60%->medium load
      (SM21, SM22): 40%->medium load
   Estimates the load associated to the traffic to be shifted per SM pair:
      (SM11, SM12): 80%->most of the traffic needs to be shifted
      (SM21, SM22): 50%->half of the traffic needs to be shifted
   Estimates a feasible traffic shifting budget per TA:
      TA1: 35 ms
      TA2: 50 ms
   Selects the most reliable traffic shifting strategy per TA:
      TA1: gradual_traffic_splitting
      TA2: constant_traffic_mirroring

Hence, the system may build the following models:
Mapped Infrastructure Model
   UPF Tuple->(UPF_id_s, UPF_id_t)
      (UPF1, UPF2)
      total_traffic_load: 80%
      traffic_shifting_load: 95%
      feasible_migration_budget: 60 ms
   UPF_id->{DN_1, . . . , DN_p}:
      UPF1->{DN11, DN21}(source)
      UPF2->{DN12, DN22}(target)
   DN Tuples->(DN_id_s, DN_id_t):
      (DN11, DN12), associated to TA1
      (DN21, DN22), associated to TA2
   DN_id->{SM_1, . . . , SM_n}:
      DN11->{SM11}
      DN12->{SM12}
      DN21->{SM21}
      DN22->{SM22}
   SM Tuple for TA1->(SM_id_s, SM_id_t):
      {SM11, SM12}, associated to TA1
      total_traffic_load: 60%
      {(gradual_traffic splitting, 35 ms), (constant_traffic_shifting, 70 ms)}
   SM Tuple for TA2->(SM_id_s, SM_id_t):
      {SM21, SM22}, associated to TA2
      total_traffic_load: 40%
      {(constant_traffic_shifting, 65 ms), (constant_trafficc_mirroring, 50 ms)}
Mapped Application Model
   QF_id->MC_id:
      QF11->MC_v1 (microservice chain v1)
      QF21->MC_m1 (microservice chain m1)
      QF31->MC_v2, MC_m2
   MC_id->{SM_1, . . . SMJ}:
      MC_v1->{SM11}
      MC_m1->{SM21}
      MC_v2->{SM11}
      MC_m2->{SM21}
Traffic and Traffic Aggregate Model
   Total Traffic
      UE_id: UE1
      {TA_QoS1, . . . , TA_QoSi}: {TA1, TA2, TA3}
   Traffic Aggregates
      MC_v1TA
         TA_id: TA1
         UserPlane_s: {PDUSession11, DRB11, QF11, SDF11, PSA11, UPF1, DN11}
         UserPlane_t: {PDUSession12, DRB12, QF12, SDF12, PSA12, UPF2, DN1}
         QoS_reqs: {latency 200 ms}
         migration_budget: 100 ms
         shift_traffic: True priority_score: 10
      MC_m1TA
         TA_id: TA2
         UserPlane_s: {PDUSession21, DRB21, QF21, SDF21, PSA21, UPF1, DN21}
         UserPlane_t: {PDUSession22, DRB22, QF22, SDF22, PSA22, UPF2, DN22}
         QoS_reqs: {latency 300 ms}
         migration_budget: 150 ms
         shift_traffic: True
         priority_score: 7
      . . .
Mapped Traffic Aggregate Model
   TAs: {(TA1, priority_score_10), (TA2, priority_score_7), (TA3, priority_score_1)}.
   ServiceMeshes:
      TA1->{SM11, SM12}
      TA2->{SM21, SM22}
   aggregated_priority_score: in this simple case where SMs have only one TA associated the aggregated and individual priority score do not differ but it may be different in more complex cases
      {SM11, SM12}: priority_10
         {SM21, SM22}: priority_7

As a summarized overview of the foregoing, it may be understood that particular embodiments herein may relate to models for inter-domain traffic aggregates, traffic shifting signaling, budget distribution and traffic shifting prioritization, based on requested migration budget, feasible migration budget, among others, in both the mobile network and the service mesh-based edge cloud.

Particular embodiments herein may relate to a system and method for performing alignment and coordination between the mobile network and the service mesh-based edge cloud to support UE-mobility events.

Some particular embodiments may provide a system and method for performing efficient inter-domain traffic shifting signaling between the mobile network and the service mesh-based edge cloud.

Some particular embodiments may provide a system and method for performing optimized selection of traffic shifting strategy in the service mesh-based edge cloud in alignment with the mobile network.

Certain embodiments disclosed herein may provide one or more of the following technical advantage(s), which may be summarized as follows.

As a first advantage, embodiments herein may be understood to be built on top of a novel and converged or aligned traffic differentiation system in service mesh-based edge cloud according to mobile network's QoS assurance and UE-session information.

As another advantage, embodiments herein may be understood to reduce cross-domain signaling, between mobile network—edge cloud, based on the concept of groups of traffic flows or traffic aggregates, thus reducing congested inter-domain control planes. This may result into reduction of communication costs and energy savings.

As another advantage, embodiments herein may be understood to enable that signaling forwarding between the mobile network and the data networks and the data network and the service meshes may be both performed considering the priority associated to the traffic aggregates based on their associated migration budget.

As a further advantage, embodiments herein may be understood to perform dynamic distribution of the available migration budget, e.g., e2e service downtime, between the mobile network and the edge cloud with optimized selection of traffic shifting strategy and optimized traffic shifting scheduling.

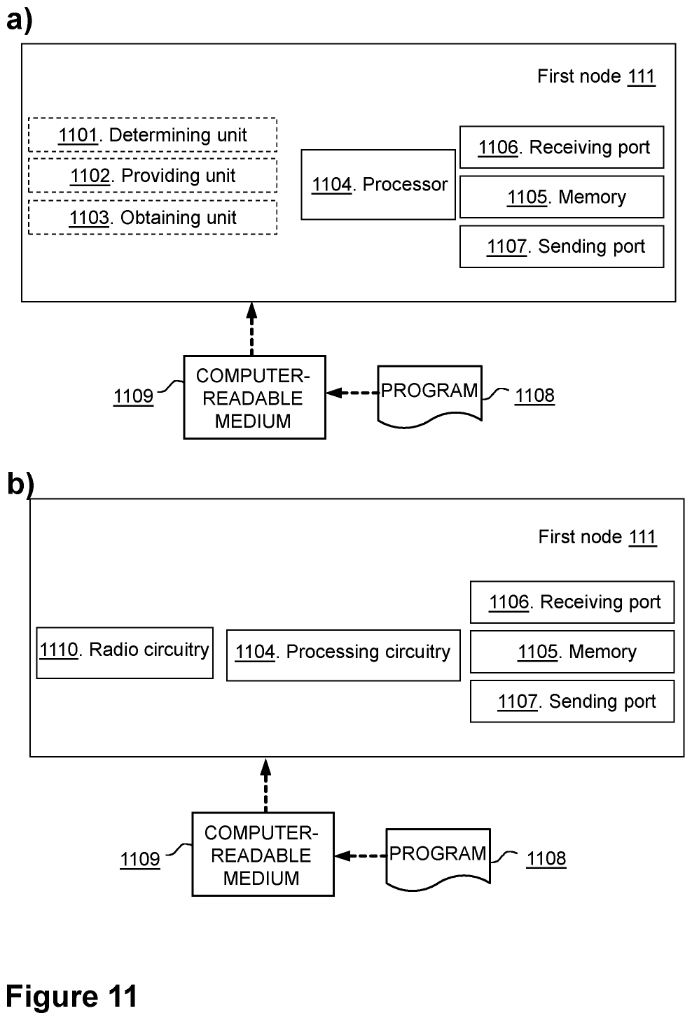

FIG. 11 depicts two different examples in panels a) and b), respectively, of the arrangement that the first node 111 may comprise to perform the method actions described above in relation to FIG. 2, and/or FIGS. 5-9. In some embodiments, the first node 111 may comprise the following arrangement depicted in FIG. 11a. The first node 111 may be understood to be for handling the mobility of the one or more ongoing communication sessions for the device 130, from the source domain 121 to the target domain 122. Each of the source domain 121 and the target domain 122 is configured to comprise at least the first communications network 101 and the second communications network 102. Each of the one or more ongoing communication sessions is configured to comprise the respective group of traffic flows having the respective requirement for the quality of service or experience. The first node 111 is configured to operate in at least one of the first communications network 101, the second communications network 102, and another communications network 103.

Several embodiments are comprised herein. Components from one embodiment may be tacitly assumed to be present in another embodiment and it will be obvious to a person skilled in the art how those components may be used in the other exemplary embodiments. In FIG. 11, optional boxes are indicated by dashed lines. The detailed description of some of the following corresponds to the same references provided above, in relation to the actions described for the first node 111 and will thus not be repeated here. For example, a group of traffic flows may be referred to herein as a traffic aggregate.

The first node 111 is configured to, e.g. by means of a determining unit 1101 within the first node 111 configured to, determine, for each respective group of traffic flows, in each of the one or more ongoing communication sessions having a similar requirement for quality of service or experience one of the following. As a first option, the respective correspondence between the respective first set of resources configured to belong to the first communications network 101 and the respective second set of resources configured to belong to the second communications network 102 configured to be estimated to be required for the shift. The first set of resources is configured to comprise the respective pair of core mobile networks, configured to comprise the one or more source mobile networks and the one or more target mobile networks. The second set of resources is configured to comprise the respective pair of service meshes, configured to comprise the source service mesh and the target service mesh. As a second option, the first node 111 is configured to configure, determine, for each respective group of traffic flows, in each of the one or more ongoing communication sessions having a similar requirement for quality of service or experience the respective priority in the shift for each respective pair of resources.

The first node 111 is also configured to, e.g. by means of the determining unit 1101 within the first node 111 configured to, determine the distribution of the time budget for the shift, between the first communications network 101 and the second communications network 102, by exchanging communications with each of the first communications network 101 and the second communications network 102. The determining of the distribution of the time budget is configured to be based on the respective pair of core mobile networks, the respective pair of service meshes and the respective priority, according to a respective end to end performance requirement for the shift.

The first node 111 is also configured to, e.g. by means of a providing unit 1102 within the first node 111 configured to, provide the one or more indications to at least one of: the second node 112 configured to operate in the first communications network 101 and the third node 113 configured to operate in the second communications network 102. The one or more indications are configured to indicate the distribution configured to be determined.

In some embodiments, the first communications network 101 may be configured to be the mobile network and the second communications network 102 may be configured to be the edge cloud network.

In some embodiments, the first node 111 may be configured to, e.g. by means of an obtaining unit 1103 within the first node 111 configured to, obtain, for each respective group of traffic flows having the similar requirement for quality of service or experience: i) from the first communications network 101, the first feasible migration budget feasible to the first communications network 101, and ii) from the second communications network 102, the second migration budget feasible to the second communications network 102. The determining of the distribution of the time budget may be configured to be further based on, the first feasible migration budget configured to be obtained and the second migration budget configured to be obtained.

In some embodiments, the one or more indications configured to be provided may be configured to be one or more third indications.

In some embodiments, the first node 111 may be further configured to, e.g. by means of the obtaining unit 1103 further configured to, obtain the one or more first indications from the second node 112. The one or more first indications may be configured to indicate the respective group of traffic flows in each of the one or more ongoing communication sessions that are to be shifted from the source domain 121 to the target domain 122. The one or more first indications may be also configured to indicate, for each respective group of traffic flows in each of the one or more ongoing communication sessions having similar requirement for quality of service or experience, at least one of: i) the respective pair of nodes configured to be estimated to be required for the shift to handle the respective group of traffic flows, the respective pair of nodes being configured to comprise the respective source node in the source domain 121 and the respective target node in the target domain 122, ii) the respective first priority in handling the shift, iii) the first respective time budget requirement for the shift, iv) the first respective load per respective pair of nodes, v) the second respective load to be shifted, per respective pair of nodes, and vi) the first feasible migration budget, per respective pair of nodes. The determining of the respective correspondence and the respective priority may be configured to be based on the one or more first indications configured to be obtained.

In some embodiments, the first node 111 may be further configured to, e.g. by means of the providing unit 1102 further configured to, provide the one or more second indications to the third node 113. The one or more second indications may be configured to be based on the one or more first indications configured to be obtained.

In some embodiments, each of the nodes in the respective pair of nodes may be configured to be one of: a) a PDU session anchor, b) a node managing a user plane, and c) a UPF. Each respective pair of nodes may be configured to correspond to a respective pair of core mobile networks and to a respective pair of service meshes.

In some embodiments, at least one of: a) each of the group of traffic flows may be configured to traverse a group of microservices, b) each of the one or more ongoing communication sessions may be configured to be a PDU session, c) each of the group of traffic flows having a similar requirement for quality of service or experience may be configured to be a traffic aggregate, and d) the one or more ongoing communication sessions may be configured to be handled by a service mesh.

The embodiments herein may be implemented through one or more processors, such as a processor 1104 in the first node 111 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1105 comprising one or more memory units. The memory 1105 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the device 130, and/or another node through a receiving port 1106. In some examples, the receiving port 1106 may be, for example, connected to one or more antennas in the first node 111. In other embodiments, the first node 111 may receive information from another structure in the communications system through the receiving port 1106. Since the receiving port 1106 may be in communication with the processor 1104, the receiving port 1106 may then send the received information to the processor 1104. The receiving port 1106 may also be configured to receive other information.

The processor 1104 in the first node 111 may be further configured to transmit or send information to e.g., the second node 112, the third node 113, the fourth node 114, the device 130, another node, and/or another structure in the communications system, through a sending port 1107, which may be in communication with the processor 1104, and the memory 1105.

Those skilled in the art will also appreciate that any of the units 1101-1103 described above may refer to a combination of analog and digital circuits, and/or one or more processors configured with software and/or firmware, e.g., stored in memory, that, when executed by the one or more processors such as the processor 1104, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1101-1103 described above may be the processor 1104 of the first node 111, or an application running on such processor.

Thus, the methods according to the embodiments described herein for the first node 111 may be respectively implemented by means of a computer program 1108 product, comprising instructions, i.e., software code portions, which, when executed on at least one processor 1104, cause the at least one processor 1104 to carry out the actions described herein, as performed by the first node 111. The computer program 1108 product may be stored on a computer-readable storage medium 1110. The computer-readable storage medium 1110, having stored thereon the computer program 1108, may comprise instructions which, when executed on at least one processor 1104, cause the at least one processor 1104 to carry out the actions described herein, as performed by the first node 111. In some embodiments, the computer-readable storage medium 1110 may be a non-transitory computer-readable storage medium, such as a CD ROM disc, a memory stick, or stored in the cloud space. In other embodiments, the computer program 1108 product may be stored on a carrier containing the computer program, wherein the carrier is one of an electronic signal, optical signal, radio signal, or the computer-readable storage medium 1110, as described above.

The first node 111 may comprise an interface unit to facilitate communications between the first node 111 and other nodes or devices, e.g., the second node 112, the third node 113, the fourth node 114, the device 130, another node, and/or another structure in the communications system. In some particular examples, the interface may, for example, include a transceiver configured to transmit and receive radio signals over an air interface in accordance with a suitable standard.

In other embodiments, the first node 111 may comprise the following arrangement depicted in FIG. 11b. The first node 111 may comprise a processing circuitry 1104, e.g., one or more processors such as the processor 1104, in the first node 111 and the memory 1105.

The first node 111 may also comprise a radio circuitry 1110, which may comprise e.g., the receiving port 1106 and the sending port 1107. The processing circuitry 1104 may be configured to, or operable to, perform the method actions according to FIG. 2, and/or FIGS. 5-9, in a similar manner as that described in relation to FIG. 11a. The radio circuitry 1110 may be configured to set up and maintain at least a wireless connection the second node 112, the third node 113, the fourth node 114, the device 130, another node, and/or another structure in the communications system.

Hence, embodiments herein also relate to the first node 111 operative for handling mobility of the one or more ongoing communication sessions for the device 130, from the source domain 121 to the target domain 122, wherein each of the source domain 121 and the target domain 122 is operative to comprise at least a first communications network 101 and a second communications network 102, each of the one or more ongoing communication sessions being operative to comprise the respective group of traffic flows having the respective requirement for a quality of service or experience, the first node 111 being operative to operate in in at least one of the first communications network 101, the second communications network 102, and the another communications network 103. The first node 111 may comprise the processing circuitry 1104 and the memory 1105, said memory 1105 containing instructions executable by said processing circuitry 1104, whereby the first node 111 is further operative to perform the actions described herein in relation to the first node 111, e.g., in FIG. 2, and/or FIGS. 5-9.

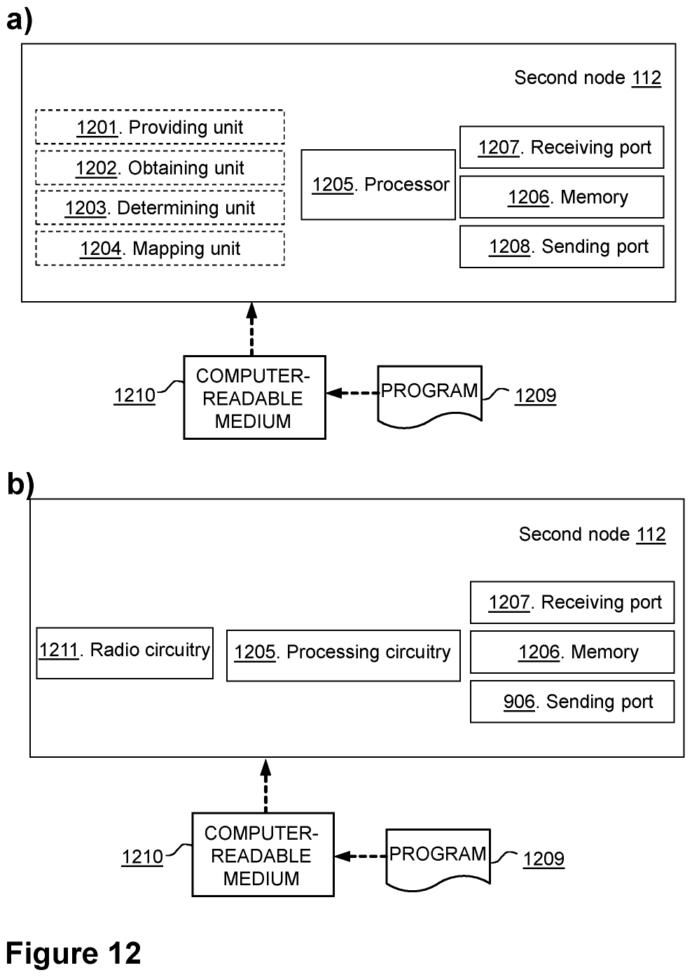

FIG. 12 depicts two different examples in panels a) and b), respectively, of the arrangement that the second node 112 may comprise to perform the method actions described above in relation to FIG. 3, and/or FIGS. 5-9. In some embodiments, the second node 112 may comprise the following arrangement depicted in FIG. 12a. The second node 112 may be understood to be for handling the mobility of the one or more ongoing communication sessions for the device 130, from the source domain 121 to the target domain 122. Each of the source domain 121 and the target domain 122 is configured to comprise at least the first communications network 101 and the second communications network 102. Each of the one or more ongoing communication sessions is configured to comprise the respective group of traffic flows having the respective requirement for the quality of service or experience. The second node 112 is configured to operate the first communications network 101.

Several embodiments are comprised herein. Components from one embodiment may be tacitly assumed to be present in another embodiment and it will be obvious to a person skilled in the art how those components may be used in the other exemplary embodiments. In FIG. 12, optional boxes are indicated by dashed lines. The detailed description of some of the following corresponds to the same references provided above, in relation to the actions described for the second node 112 and will thus not be repeated here. For example, a group of traffic flows may be referred to herein as a traffic aggregate.

The second node 112 is configured to, e.g. by means of a providing unit 1201 within the second node 112 configured to, provide, to the first node 111 configured to operate in at least one of the first communications network 101, the second communications network 102, and another communications network 103, for each respective group of traffic flows in each of the one or more ongoing communication sessions having a similar requirement for quality of service or experience, the first feasible migration budget feasible to the first communications network 101.

The second node 112 is also configured to, e.g. by means of an obtaining unit 1202 within the second node 112 configured to, obtain, from the first node 111, the one or more third indications configured to indicate, for each respective group of traffic flows in each of the one or more ongoing communication sessions that are to be shifted from the source domain 121 to the target domain 122, each of the respective group of traffic flows having the similar requirement for quality of service or experience, the distribution of the time budget for the shift between the source domain 121 and the target domain 122. The distribution of the time budget configured to be obtained is configured to be based on the first feasible migration budget feasible to the first communications network 101 configured to be provided, and the respective end to end performance requirement for the shift.

In some embodiments, the first communications network 101 may be configured to be the mobile network and the second communications network 102 may be configured to be the edge cloud network.

In some embodiments, the distribution of the time budget for the shift configured to be obtained may be further configured to be based on, for each respective group of traffic flows, in each of the one or more ongoing communication sessions having the similar requirement for quality of service or experience: i) the respective correspondence between the respective first set of resources configured to belong to the first communications network 101 and the respective second set of resources configured to belong to the second communications network 102 configured to estimate to be required for the shift. The first set of resources may be configured to comprise the respective pair of one or more source core mobile networks and the one of one or more target mobile networks. The second set of resources may be configured to comprise the respective pair of service meshes, configured to comprise the source service mesh and the target service mesh. The distribution of the time budget for the shift configured to be obtained may also be further configured to be based on, for each respective group of traffic flows, in each of the one or more ongoing communication sessions having the similar requirement for quality of service or experience: ii) the respective priority in the shift for each respective pair of resources.

The second node 112 may also be configured to, e.g. by means of a determining unit 1202 within the second node 112 configured to, determine the respective group of traffic flows in each of the one or more ongoing communication sessions having the similar respective requirement for quality of service or experience, that are to be shifted from the source domain 121 to the target domain 122.

The second node 112 may also be configured to, e.g. by means of the determining unit 1202 within the second node 112 configured to, determine, for each of the respective group of traffic flows configured to be determined, and based on the respective requirement for the quality of service or experience, at least one of: i) the respective pair of nodes configured to be estimated to be required for the shift to handle the respective group of traffic flows, the respective pair of nodes being configured to comprise the respective source node in the source domain 121 and the respective target node in the target domain 122, ii) the respective first priority in handling the shift, iii) the first respective time budget requirement for the shift, iv) the first respective load per respective pair of nodes, v) second respective load to be shifted, per respective pair of nodes, and vi) the first feasible migration budget, per respective pair of nodes.

The second node 112 may also be configured to, e.g. by means of the providing unit 1201 within the second node 112 configured to, provide the one or more first indications to the first node 111. The one or more first indications may be configured to indicate at least one of: i) the respective group of traffic flows in each of the one or more ongoing communication sessions that are to be shifted from the source domain 121 to the target domain 122, and ii) for each respective group of traffic flows in each of the one or more ongoing communication sessions having the similar requirement for quality of service or experience, the determined at least one of: a) the respective pair of nodes configured to be estimated to be required for the shift to handle the respective group of traffic flows, the respective pair of nodes being configured to comprise a respective source node in the source domain 121 and a respective target node in the target domain 122, b) the respective first priority in handling the shift, c) the first respective time budget requirement for the shift, d) the first respective load per respective pair of nodes, e) the second respective load to be shifted, per respective pair of nodes, and f) the first feasible migration budget, per respective pair of nodes.

In some embodiments, each of the nodes in the respective pair of nodes may be configured to be one of: a) a PDU session anchor, b) a node managing a user plane, and c) a UPF. Each respective pair of nodes may be configured to correspond to a respective pair of core mobile networks and to a respective pair of service meshes.

In some embodiments, at least one of: a) each of the group of traffic flows may be configured to traverse a group of microservices, b) each of the one or more ongoing communication sessions may be configured to be a PDU session, c) each of the group of traffic flows having a similar requirement for quality of service or experience may be configured to be a traffic aggregate, and d) the one or more ongoing communication sessions may be configured to be handled by a service mesh.

The second node 112 may also be configured to, e.g. by means of the determining unit 1202 within the second node 112 configured to, determine, from all services in each of the one or more ongoing communication sessions for the device 130, the one or more chains of services configured to have the requirement to be performed in the respective sequence over time.

The second node 112 may also be configured to, e.g. by means of a mapping unit 1204 within the second node 112 configured to, map the one or more chains of services configured to be determined to the respective group of traffic flows configured to have the respective requirement for the quality of service or experience.

The second node 112 may also be configured to, e.g. by means of the determining unit 1202 within the second node 112 configured to, determine the respective end to end performance requirement for each of the respective group of traffic flows configured to be determined. The determining of the respective first priority may be configured to be based on the respective end to end performance requirement configured to be determined.

The embodiments herein may be implemented through one or more processors, such as a processor 1205 in the second node 112 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1206 comprising one or more memory units. The memory 1206 is arranged to be used to store obtained information, store data, configurations, schedulings, and applications etc. to perform the methods herein when being executed in the second node 112.

In some embodiments, the second node 112 may receive information from, e.g., the first node 111, the third node 113, another node, and/or the device 130 through a receiving port 1207. In some examples, the receiving port 1207 may be, for example, connected to one or more antennas in the second node 112. In other embodiments, the second node 112 may receive information from another structure in the communications system through the receiving port 1207. Since the receiving port 1207 may be in communication with the processor 1205, the receiving port 1207 may then send the received information to the processor 1205. The receiving port 1207 may also be configured to receive other information.

The processor 1205 in the second node 112 may be further configured to transmit or send information to e.g., the first node 111, the third node 113, another node, the device 130 and/or another structure in the communications system, through a sending port 1208, which may be in communication with the processor 1205, and the memory 1206.

Those skilled in the art will also appreciate that any of the units 1201-1204 described above may refer to a combination of analog and digital circuits, and/or one or more processors configured with software and/or firmware, e.g., stored in memory, that, when executed by the one or more processors such as the processor 1205, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1201-1204 described above may be the processor 1205 of the second node 112, or an application running on such processor.

Thus, the methods according to the embodiments described herein for the second node 112 may be respectively implemented by means of a computer program 1209 product, comprising instructions, i.e., software code portions, which, when executed on at least one processor 1205, cause the at least one processor 1205 to carry out the actions described herein, as performed by the second node 112. The computer program 1209 product may be stored on a computer-readable storage medium 1210. The computer-readable storage medium 1210, having stored thereon the computer program 1209, may comprise instructions which, when executed on at least one processor 1205, cause the at least one processor 1205 to carry out the actions described herein, as performed by the second node 112. In some embodiments, the computer-readable storage medium 1210 may be a non-transitory computer-readable storage medium, such as a CD ROM disc, a memory stick, or stored in the cloud space. In other embodiments, the computer program 1209 product may be stored on a carrier containing the computer program, wherein the carrier is one of an electronic signal, optical signal, radio signal, or the computer-readable storage medium 1210, as described above.

The second node 112 may comprise an interface unit to facilitate communications between the second node 112 and other nodes or devices, e.g., the first node 111, the third node 113, another node, the device 130 and/or another structure in the communications system. In some particular examples, the interface may, for example, include a transceiver configured to transmit and receive radio signals over an air interface in accordance with a suitable standard.

In other embodiments, the second node 112 may comprise the following arrangement depicted in FIG. 12b. The second node 112 may comprise a processing circuitry 1205, e.g., one or more processors such as the processor 1205, in the second node 112 and the memory 1206. The second node 112 may also comprise a radio circuitry 1211, which may comprise e.g., the receiving port 1207 and the sending port 1208. The processing circuitry 1205 may be configured to, or operable to, perform the method actions according to FIG. 3, and/or FIGS. 5-9, in a similar manner as that described in relation to FIG. 12a. The radio circuitry 1211 may be configured to set up and maintain at least a wireless connection with the first node 111, the third node 113, another node, the device 130 and/or another structure in the communications system.

Hence, embodiments herein also relate to the second node 112 operative for handling the mobility of the one or more ongoing communication sessions for the device 130, from the source domain 121 to the target domain 122, wherein each of the source domain 121 and the target domain 122 is operative to comprise at least the first communications network 101 and the second communications network 102, each of the one or more ongoing communication sessions being operative to comprise the respective group of traffic flows having the respective requirement for a quality of service or experience, the second node 112 being operative to operate in the first communications network 101. The second node 112 may comprise the processing circuitry 1205 and the memory 1206, said memory 1206 containing instructions executable by said processing circuitry 1205, whereby the second node 112 is further operative to perform the actions described herein in relation to the second node 112, e.g., in FIG. 3, and/or FIGS. 5-9.

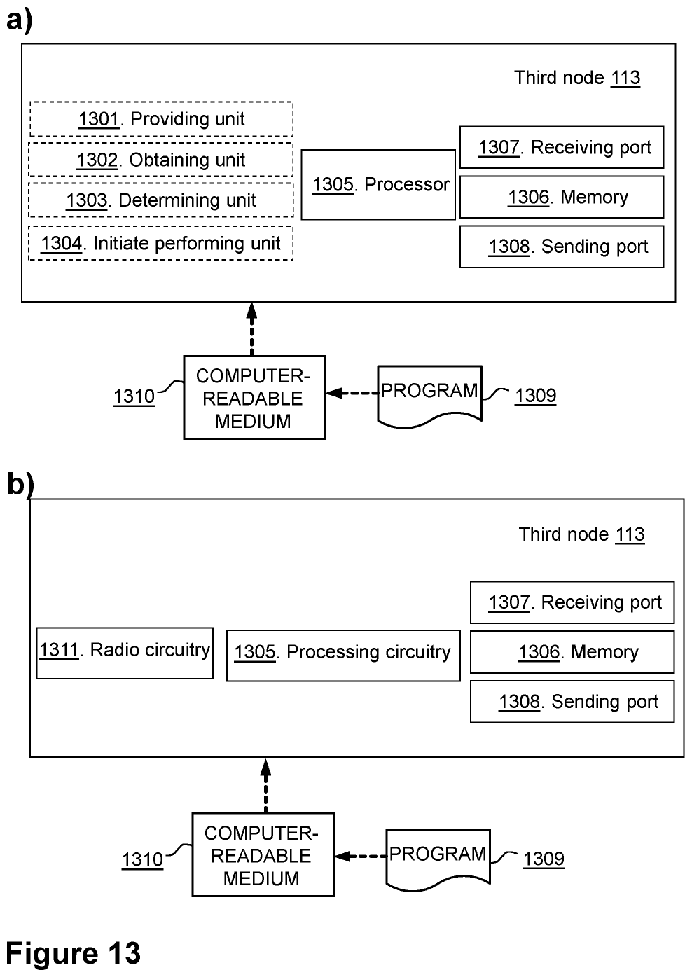

FIG. 13 depicts two different examples in panels a) and b), respectively, of the arrangement that the third node 113 may comprise to perform the method actions described above in relation to FIG. 4, and/or FIGS. 5-9. In some embodiments, the third node 113 may comprise the following arrangement depicted in FIG. 13a. The third node 113 may be understood to be for handling the mobility of the one or more ongoing communication sessions for the device 130, from the source domain 121 to the target domain 122. Each of the source domain 121 and the target domain 122 is configured to comprise at least the first communications network 101 and the second communications network 102. Each of the one or more ongoing communication sessions is configured to comprise the respective group of traffic flows having the respective requirement for the quality of service or experience. The third node 113 is configured to operate in the second communications network 102.

Several embodiments are comprised herein. Components from one embodiment may be tacitly assumed to be present in another embodiment and it will be obvious to a person skilled in the art how those components may be used in the other exemplary embodiments. In FIG. 13, optional boxes are indicated by dashed lines. The detailed description of some of the following corresponds to the same references provided above, in relation to the actions described for the third node 113 and will thus not be repeated here. For example, a group of traffic flows may be referred to herein as a traffic aggregate.

The third node 113 is configured to, e.g. by means of a providing unit 1301 within the third node 113 configured to, provide, to the first node 111 configured to operate in at least one of the first communications network 101, the second communications network 102, and the another communications network 103, for each respective group of traffic flows in each of the one or more ongoing communication sessions having the similar requirement for quality of service or experience, the second migration budget feasible to the second communications network 102.

The third node 113 is also configured to, e.g. by means of an obtaining unit 1302 within the third node 113 configured to, obtain, from the first node 111, the one or more third indications configured to indicate, for each respective group of traffic flows in each of the one or more ongoing communication sessions that are to be shifted from the source domain 121 to the target domain 122, each of the respective group of traffic flows having the similar requirement for quality of service or experience, the distribution of the time budget for the shift between the first communications network 101 and the second communications network 102. The distribution of the time budget configured to be obtained is configured to be based on the second migration budget feasible to the second communications network 102 configured to be provided.

In some embodiments, the first communications network 101 may be configured to be the mobile network and the second communications network 102 may be configured to be the edge cloud network.

The third node 113 may be further configured to, e.g. by means of a determining unit 1303 within the third node 113 configured to, determine, based on the one or more third indications configured to be obtained, and available resources at the second communications network 102, as configured to be estimated by the third node 113, the strategy for the shift.

The third node 113 may be further configured to, e.g. by means of an initiating determining unit 1304 within the third node 113 configured to, initiate performing the shift, based on the strategy configured to be determined.

The third node 113 may be configured to, e.g. by means of the obtaining unit 1302 within the third node 113 configured to, obtain the one or more second indications from the first node 111. The one or more second indications may be configured to indicate, for each respective group of traffic flows in each of the one or more ongoing communication sessions that are to be shifted from the source domain 121 to the target domain 122 having the similar requirement for quality of service or experience, at least one of: i) the respective first set of resources in the first communications network 101 configured to be estimated to be required for the shift, ii) the respective second set of resources in the second communications network 102 configured to be estimated to be required for the shift, and iii) the respective first priority in handling the shift. The second migration budget configured to be provided may be configured to be based on the one or more second indications configured to be obtained.

In some embodiments, the respective first set of resources may be configured to comprise at least one of: i) the respective pair of nodes configured to be estimated to be required for the shift to handle the respective group of traffic flows, the respective pair of nodes being configured to comprise the respective source node in the source domain 121 and the respective target node in the target domain 122, ii) the respective first priority in handling the shift, iii) the first respective time budget requirement for the shift, iv) the first respective load per respective pair of nodes, v) the second respective load to be shifted, per respective pair of nodes, and vi) the first feasible migration budget, per respective pair of nodes.

In some embodiments, each of the nodes in the respective pair of nodes may be configured to be one of: a) a PDU session anchor, b) a node managing a user plane, and c) a UPF. Each respective pair of nodes may be configured to correspond to the respective pair of core mobile networks and to the respective pair of service meshes.

In some embodiments, at least one of: a) each of the group of traffic flows may be configured to traverse a group of microservices, b) each of the one or more ongoing communication sessions may be configured to be a PDU session, c) each of the group of traffic flows having a similar requirement for quality of service or experience may be configured to be a traffic aggregate, and d) the one or more ongoing communication sessions may be configured to be handled by a service mesh.

In some embodiments, third node 113 may be configured to, e.g. by means of the determining unit 1303 within the third node 113 configured to, determine, for each pair of respective service meshes: i) the respective load, ii) the respective load corresponding to the traffic to be shifted, and iii) the second migration budget feasible to the second communications networks 102. The second migration budget may be configured to be determined based on the respective load configured to be determined and the respective load configured to correspond to the traffic to be shifted.

In some embodiments, the strategy for the shift configured to be determined may be configured to be further based on the respective load configured to be determined. The respective load may be configured to correspond to the traffic to be shifted, and the respective first priority.

The embodiments herein may be implemented through one or more processors, such as a processor 1305 in the third node 113 depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1306 comprising one or more memory units. The memory 1306 is arranged to be used to store obtained information, store data, configurations, schedulings, and applications etc. to perform the methods herein when being executed in the third node 113.

In some embodiments, the third node 113 may receive information from, e.g., the first node 111, the second node 112, another node, and/or of the device 130, through a receiving port 1307. In some examples, the receiving port 1307 may be, for example, connected to one or more antennas in the third node 113. In other embodiments, the third node 113 may receive information from another structure in the communications system through the receiving port 1307. Since the receiving port 1307 may be in communication with the processor 1305, the receiving port 1307 may then send the received information to the processor 1305. The receiving port 1307 may also be configured to receive other information.

The processor 1305 in the third node 113 may be further configured to transmit or send information to e.g., the first node 111, the second node 112, another node, the device 130, and/or another structure in the communications system, through a sending port 1308, which may be in communication with the processor 1305, and the memory 1306.

Those skilled in the art will also appreciate that the units 1301-1304 described above may refer to a combination of analog and digital circuits, and/or one or more processors configured with software and/or firmware, e.g., stored in memory, that, when executed by the one or more processors such as the processor 1305, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1301-1304 described above may be the processor 1305 of the third node 113, or an application running on such processor.

Thus, the methods according to the embodiments described herein for the third node 113 may be respectively implemented by means of a computer program 1309 product, comprising instructions, i.e., software code portions, which, when executed on at least one processor 1305, cause the at least one processor 1305 to carry out the actions described herein, as performed by the third node 113. The computer program 1309 product may be stored on a computer-readable storage medium 1310. The computer-readable storage medium 1310, having stored thereon the computer program 1309, may comprise instructions which, when executed on at least one processor 1305, cause the at least one processor 1305 to carry out the actions described herein, as performed by the third node 113. In some embodiments, the computer-readable storage medium 1310 may be a non-transitory computer-readable storage medium, such as a CD ROM disc, a memory stick, or stored in the cloud space. In other embodiments, the computer program 1309 product may be stored on a carrier containing the computer program, wherein the carrier is one of an electronic signal, optical signal, radio signal, or the computer-readable storage medium 1310, as described above.

The third node 113 may comprise an interface unit to facilitate communications between the third node 113 and other nodes or devices, e.g., the first node 111, the second node 112, another node, any of the device 130, and/or another structure in the communications system. In some particular examples, the interface may, for example, include a transceiver configured to transmit and receive radio signals over an air interface in accordance with a suitable standard.

In other embodiments, the third node 113 may comprise the following arrangement depicted in FIG. 13b. The third node 113 may comprise a processing circuitry 1305, e.g., one or more processors such as the processor 1305, in the third node 113 and the memory 1306. The third node 113 may also comprise a radio circuitry 1311, which may comprise e.g., the receiving port 1307 and the sending port 1308. The processing circuitry 1305 may be configured to, or operable to, perform the method actions according to FIG. 4, and/or FIGS. 5-9, in a similar manner as that described in relation to FIG. 13a. The radio circuitry 1311 may be configured to set up and maintain at least a wireless connection with the first node 111, the second node 112, another node, any of the device 130, and/or another structure in the communications system.

Hence, embodiments herein also relate to the third node 113 operative for handling mobility of the one or more ongoing communication sessions for the device 130, from the source domain 121 to the target domain 122, wherein each of the source domain 121 and the target domain 122 is operative to comprise at least a first communications network 101 and a second communications network 102, each of the one or more ongoing communication sessions being operative to comprise the respective group of traffic flows having the respective requirement for a quality of service or experience, the third node 113 being operative to operate the second communications network 102. The third node 113 may comprise the processing circuitry 1305 and the memory 1306, said memory 1306 containing instructions executable by said processing circuitry 1305, whereby the third node 113 is further operative to perform the actions described herein in relation to the third node 113, e.g., in FIG. 4, and/or FIGS. 5-9.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCE

[1]S. Rommer, P. Hedman, M. Olsson, L. Frid, S. Sultana and C. Mulligan, 5G Core Networks Powering Digitalization, London: Elsevier Ktd., 2020.

1-44. (canceled)

45. A method, performed by a first node, the method being for handling mobility of one or more ongoing communication sessions for a device, from a source domain to a target domain, wherein each of the source domain and the target domain comprises at least a first communications network and a second communications network, each of the one or more ongoing communication sessions comprising a respective group of traffic flows having a respective requirement for a quality of service or experience, the first node operating in at least one of the first communications network, the second communications network, and another communications network, the method comprising:
determining, for each respective group of traffic flows, in each of the one or more ongoing communication sessions having a similar requirement for quality of service or experience:
a respective correspondence between a respective first set of resources belonging to the first communications network and a respective second set of resources belonging to the second communications network estimated to be required for a shift, wherein:
the first set of resources comprises a respective pair of core mobile networks, comprising one or more source mobile networks and one or more target mobile networks; and
the second set of resources comprises a respective pair of service meshes, comprising a source service mesh and a target service mesh and a respective priority in the shift for each respective pair of resources;
determining a distribution of a time budget for the shift, between the first communications network and the second communications network, by exchanging communications with each of the first communications network and the second communications network, wherein the determining of the distribution of the time budget is based on the respective pair of core mobile networks, the respective pair of service meshes and the respective priority, according to a respective end to end performance requirement for the shift; and
providing one or more indications to at least one of: a second node operating in the first communications network and a third node operating in the second communications network, the one or more indications indicating the determined distribution.

46. The method according to claim 45, wherein the first communications network is a mobile network, and the second communications network is an edge cloud network.

47. The method according to claim 45, further comprising:
obtaining, for each respective group of traffic flows having the similar requirement for quality of service or experience:
from the first communications network, a first feasible migration budget feasible to the first communications network; and
from the second communications network, a second migration budget feasible to the second communications network; and
wherein the determining of the distribution of the time budget is further based on, the obtained first feasible migration budget and the obtained second migration budget.

48. The method according to claim 47, wherein the provided one or more indications are one or more third indications, the method further comprising:
obtaining one or more first indications from the second node, the one or more first indications indicating the respective group of traffic flows in each of the one or more ongoing communication sessions that are to be shifted from the source domain to the target domain and, for each respective group of traffic flows in each of the one or more ongoing communication sessions having similar requirement for quality of service or experience, at least one of:
a respective pair of nodes estimated to be required for the shift to handle the respective group of traffic flows, the respective pair of nodes comprising a respective source node in the source domain and a respective target node in the target domain;
a respective first priority in handling the shift;
a first respective time budget requirement for the shift;
a first respective load per respective pair of nodes;
a second respective load to be shifted, per respective pair of nodes; and
the first feasible migration budget, per respective pair of nodes; and
wherein the determining of the respective correspondence and the respective priority is based on the obtained one or more first indications; and
providing one or more second indications to the third node, the one or more second indications being based on the obtained one or more first indications.

49. The method according to claim 48, wherein each of the nodes in the respective pair of nodes is one of:
a Protocol Data Unit, PDU, session anchor,
a node managing a user plane, and
a User Plane Function, UPF; and
wherein each respective pair of nodes corresponds to a respective pair of core mobile networks and to a respective pair of service meshes.

50. The method according to claim 45, wherein at least one of:
each of the group of traffic flows traverses a group of microservices,
each of the one or more ongoing communication sessions is a PDU session,
each of the group of traffic flows having a similar requirement for quality of service or experience is a traffic aggregate, and
the one or more ongoing communication sessions are handled by a service mesh.

51. A method, performed by a third node, the method being for handling mobility of one or more ongoing communication sessions for a device, from a source domain to a target domain, wherein each of the source domain and the target domain comprises at least a first communications network and a second communications network, each of the one or more ongoing communication sessions comprising a respective group of traffic flows having a respective requirement for a quality of service or experience, the third node operating in the second communications network, the method comprising:
providing, to a first node operating in at least one of the first communications network, the second communications network, and another communications network, for each respective group of traffic flows in each of the one or more ongoing communication sessions having a similar requirement for quality of service or experience, a second migration budget feasible to the second communications network; and
obtaining, from the first node, one or more third indications indicating, for each respective group of traffic flows in each of the one or more ongoing communication sessions that are to be shifted from the source domain to the target domain, each of the respective group of traffic flows having the similar requirement for quality of service or experience, a distribution of a time budget for a shift between the first communications network and the second communications network, wherein the obtained distribution of the time budget is based on the provided second migration budget feasible to the second communications network.

52. The method according to claim 51, wherein the first communications network is a mobile network and the second communications network is an edge cloud network.

53. The method according to claim 51, further comprising:
determining, based on the obtained one or more third indications, and available resources at the second communications network, as estimated by the third node, a strategy for the shift; and
initiating performing the shift, based on the determined strategy.

54. The method according to claim 51, further comprising:
obtaining one or more second indications from the first node, the one or more second indications indicating, for each respective group of traffic flows in each of the one or more ongoing communication sessions that are to be shifted from the source domain to the target domain having the similar requirement for quality of service or experience, at least one of:
a respective first set of resources in the first communications network estimated to be required for the shift;
a respective second set of resources in the second communications network estimated to be required for the shift; and
a respective first priority in handling the shift; and
wherein the provided second migration budget is based on the obtained one or more second indications.

55. The method according to claim 54, wherein the respective first set of resources comprise at least one of:
a respective pair of nodes estimated to be required for the shift to handle the respective group of traffic flows, the respective pair of nodes comprising a respective source node in the source domain and a respective target node in the target domain,
a respective first priority in handling the shift,
a first respective time budget requirement for the shift,
a first respective load per respective pair of nodes,
a second respective load to be shifted, per respective pair of nodes, and
the first feasible migration budget, per respective pair of nodes.

56. The method according to claim 55, wherein each of the nodes in the respective pair of nodes is one of:
a Protocol Data Unit, PDU, session anchor,
a node managing a user plane, and
a User Plane Function, UPF, and
wherein each respective pair of nodes corresponds to a respective pair of core mobile networks and to a respective pair of service meshes.

57. A method, performed by a second node, the method being for handling mobility of one or more ongoing communication sessions for a device, from a source domain to a target domain, wherein each of the source domain and the target domain comprises at least a first communications network and a second communications network, each of the one or more ongoing communication sessions comprising a respective group of traffic flows having a respective requirement for a quality of service or experience, the second node operating in the first communications network, the method comprising:
providing, to a first node operating in at least one of the first communications network, the second communications network, and another communications network, for each respective group of traffic flows in each of the one or more ongoing communication sessions having a similar requirement for quality of service or experience, a first feasible migration budget feasible to the first communications network; and
obtaining, from the first node, one or more third indications indicating, for each respective group of traffic flows in each of the one or more ongoing communication sessions that are to be shifted from the source domain to the target domain, each of the respective group of traffic flows having the similar requirement for quality of service or experience, a distribution of a time budget for the shift between the source domain and the target domain, wherein the obtained distribution of the time budget is based on the provided first feasible migration budget feasible to the first communications network, and a respective end to end performance requirement for the shift.

58. The method according to claim 57, wherein the first communications network is a mobile network and the second communications network is an edge cloud network.

59. The method according to claim 57, wherein the obtained distribution of the time budget for the shift is further based on, for each respective group of traffic flows, in each of the one or more ongoing communication sessions having the similar requirement for quality of service or experience:
a respective correspondence between a respective first set of resources belonging to the first communications network and a respective second set of resources belonging to the second communications network estimated to be required for the shift, wherein:
the first set of resources comprises a respective pair of one or more source core mobile networks and one of one or more target mobile networks; and
the second set of resources comprises a respective pair of service meshes comprising a source service mesh and a target service mesh; and
a respective priority in the shift for each respective pair of resources.

60. The method according to claim 57, the method further comprising:
determining the respective group of traffic flows in each of the one or more ongoing communication sessions having the similar respective requirement for quality of service or experience, that are to be shifted from the source domain to the target domain; and
determining, for each of the determined respective group of traffic flows, and based on the respective requirement for the quality of service or experience, at least one of:
a respective pair of nodes estimated to be required for the shift to handle the respective group of traffic flows, the respective pair of nodes comprising a respective source node in the source domain and a respective target node in the target domain,
a respective first priority in handling the shift,
a first respective time budget requirement for the shift,
a first respective load per respective pair of nodes,
a second respective load to be shifted, per respective pair of nodes, and
the first feasible migration budget, per respective pair of nodes, and
providing one or more first indications to the first node, the one or more first indications indicating at least one of:
the respective group of traffic flows in each of the one or more ongoing communication sessions that are to be shifted from the source domain to the target domain, and
for each respective group of traffic flows in each of the one or more ongoing communication sessions having the similar requirement for quality of service or experience, the determined at least one of:
the respective pair of nodes estimated to be required for the shift to handle the respective group of traffic flows, the respective pair of nodes comprising a respective source node in the source domain and a respective target node in the target domain,
the respective first priority in handling the shift,
the first respective time budget requirement for the shift,
the first respective load per respective pair of nodes,
the second respective load to be shifted, per respective pair of nodes, and
the first feasible migration budget, per respective pair of nodes.

61. The method according to claim 60, wherein each of the nodes in the respective pair of nodes is one of:
a Protocol Data Unit, PDU, session anchor,
a node managing a user plane, and
a User Plane Function, UPF; and
wherein each respective pair of nodes corresponds to a respective pair of core mobile networks and to a respective pair of service meshes.

62. The method according to claim 57, wherein at least one of:
each of the group of traffic flows traverses a group of microservices,
each of the one or more ongoing communication sessions is a PDU session,
each of the group of traffic flows having a similar requirement for quality of service or experience is a traffic aggregate, and
the one or more ongoing communication sessions are handled by a service mesh.

63. A first node for handling mobility of one or more ongoing communication sessions for a device, from a source domain to a target domain, wherein each of the source domain and the target domain is configured to comprise at least a first communications network and a second communications network, each of the one or more ongoing communication sessions being configured to comprise a respective group of traffic flows having a respective requirement for a quality of service or experience, the first node comprising:
processing circuitry and memory containing instructions executable by the processing circuitry whereby the first node is configured to:
operate in at least one of the first communications network, the second communications network, and another communications network;
determine, for each respective group of traffic flows, in each of the one or more ongoing communication sessions having a similar requirement for quality of service or experience:
a respective correspondence between a respective first set of resources belonging to the first communications network and a respective second set of resources belonging to the second communications network estimated to be required for a shift, wherein:
the first set of resources comprises a respective pair of core mobile networks, comprising one or more source mobile networks and one or more target mobile networks; and
the second set of resources comprises a respective pair of service meshes, comprising a source service mesh and a target service mesh and a respective priority in the shift for each respective pair of resources;
determine a distribution of a time budget for the shift, between the first communications network and the second communications network, by exchanging communications with each of the first communications network and the second communications network, wherein the determining of the distribution of the time budget is based on the respective pair of core mobile networks, the respective pair of service meshes and the respective priority, according to a respective end to end performance requirement for the shift; and
provide one or more indications to at least one of: a second node operating in the first communications network and a third node operating in the second communications network, the one or more indications indicating the determined distribution.

64. The first node of claim 63, wherein the first communications network is a mobile network, and the second communications network is an edge cloud network.

65. The first node of claim 63, wherein the first node is further configured to:
obtain, for each respective group of traffic flows having the similar requirement for quality of service or experience:
from the first communications network, a first feasible migration budget feasible to the first communications network; and
from the second communications network, a second migration budget feasible to the second communications network; and
wherein the determining of the distribution of the time budget is further based on, the obtained first feasible migration budget and the obtained second migration budget.

66. A third node for handling mobility of one or more ongoing communication sessions for a device, from a source domain to a target domain, wherein each of the source domain and the target domain is configured to comprise at least a first communications network and a second communications network, each of the one or more ongoing communication sessions being configured to comprise a respective group of traffic flows having a respective requirement for a quality of service or experience, the third node comprising:
processing circuitry and memory containing instructions executable by the processing circuitry whereby the third node is configured to:
operate in the second communications network;
provide, to a first node operating in at least one of the first communications network, the second communications network, and another communications network, for each respective group of traffic flows in each of the one or more ongoing communication sessions having a similar requirement for quality of service or experience, a second migration budget feasible to the second communications network; and
obtain, from the first node, one or more third indications indicating, for each respective group of traffic flows in each of the one or more ongoing communication sessions that are to be shifted from the source domain to the target domain, each of the respective group of traffic flows having the similar requirement for quality of service or experience, a distribution of a time budget for a shift between the first communications network and the second communications network, wherein the obtained distribution of the time budget is based on the provided second migration budget feasible to the second communications network.

67. The third node of claim 66, wherein the first communications network is a mobile network and the second communications network is an edge cloud network.

68. The third node of claim 66, the third node is further configured to:
determine, based on the obtained one or more third indications, and available resources at the second communications network, as estimated by the third node, a strategy for the shift; and
initiate performing the shift, based on the determined strategy.

69. A second node for handling mobility of one or more ongoing communication sessions for a device, from a source domain to a target domain, wherein each of the source domain and the target domain is configured to comprise at least a first communications network and a second communications network, each of the one or more ongoing communication sessions being configured to comprise a respective group of traffic flows having a respective requirement for a quality of service or experience, the second node comprising:
processing circuitry and memory containing instructions executable by the processing circuitry whereby the second node is configured to:
operate in the first communications network;
provide, to a first node operating in at least one of the first communications network, the second communications network, and another communications network, for each respective group of traffic flows in each of the one or more ongoing communication sessions having a similar requirement for quality of service or experience, a first feasible migration budget feasible to the first communications network; and
obtain, from the first node, one or more third indications indicating, for each respective group of traffic flows in each of the one or more ongoing communication sessions that are to be shifted from the source domain to the target domain, each of the respective group of traffic flows having the similar requirement for quality of service or experience, a distribution of a time budget for the shift between the source domain and the target domain, wherein the obtained distribution of the time budget is based on the provided first feasible migration budget feasible to the first communications network, and a respective end to end performance requirement for the shift.

70. The second node of claim 69, wherein the first communications network is a mobile network and the second communications network is an edge cloud network.
